(19) United States
(12) Patent Application Publication
(10) Pub. No.: US 2026/0009988 A1
(43) Pub. Date: Jan. 8, 2026

(54) TECHNOLOGIES FOR ROTARY NONLINEAR MICROSCOPE WITH LARGE FIELD OF VIEW AND LARGE NUMERICAL APERTURE

(71) Applicant: Light Conversion, UAB, Vilnius (LT)

(72) Inventors: Simas Sobutas, Vilnius (LT); Lukas Kontenis, Vilnius (LT); Romualdas Danielius, Neringa (LT)

(21) Appl. No.: 19/261,191

(22) Filed: Jul. 7, 2025

Related U.S. Application Data
(60) Provisional application No. 63/668,444, filed on Jul. 8, 2024.

(51) Int. Cl. G02B 21/00

(52) U.S. Cl. CPC G02B 21/006; G02B 21/0076; G02B 21/008

(57) ABSTRACT

A nonlinear microscopy device includes a rotational optical assembly configured to rotate about an imaginary rotational axis and a radial optical assembly that is translatable radially relative to the imaginary rotational axis. The rotational optical assembly includes beam delivery optics to transmit a laser beam to the radial optical assembly, and the radial optical assembly includes an objective lens to focus the laser beam to a focus point, which may be on a sample. While the rotational optical assembly is rotated, the radial optical assembly is moved radially relative to the rotational axis. Secondary light generated by the sample is collected by the objective lens and directed to a detector. The signal received by the detector is converted into a two-dimensional image of the sample. Other embodiments are described and claimed.

### CROSS-REFERENCE TO RELATED APPLICATION

This application claims the benefit of and priority to U.S. Patent Application No. 63/668,444, entitled “TECHNOLOGIES FOR ROTARY NONLINEAR MICROSCOPE WITH LARGE FIELD OF VIEW AND LARGE NUMERICAL APERTURE,” which was filed on Jul. 8, 2024, and which is incorporated herein by reference in its entirety.

### FIELD OF THE INVENTION

This invention generally relates to nonlinear laser microscopy and more specifically to laser scanning over a wide field of view with tight focusing for nonlinear optical imaging with sub-micron resolution in/ex vivo.

### BACKGROUND

Nonlinear optical microscopy is a noninvasive imaging technique that is capable of sub-micron volumetric imaging in clear and scattering samples. The nonlinear signal is only generated at the diffraction-limited focal volume. Tightly localized nonlinear excitation also ensures optical sectioning and volumetric imaging capability. Two or more photons can be combined to excite extrinsic fluorophores and fluorescent proteins (e.g., GFP, RFP and others, and genetically-encoded calcium indicators (GECIs) such as GCaMP) or intrinsic fluorescent molecules (e.g., NADH, FAD, keratin, melanin, elastin). In addition to fluorescence, there are coherent nonlinear modalities such as SHG that are emitted by noncentrosymmetric structures such as tissues containing collagen and myosin, THG from optical interfaces, cell walls, and red blood cells (RBCs). Furthermore, coherent interaction with the vibrational modes of the sample molecules gives rise to chemically-specific signals such as coherent anti-Stokes Raman scattering (CARS) and stimulated Raman scattering (SRS) in lipids, proteins, and water. The polarization response of nonlinear signals can further be exploited for even richer imaging information content.

Nonlinear imaging has a useful depth penetration advantage. Many fluorophores absorb in the visible range, and therefore the near-infrared (NIR) and short-wave infrared (SWIR) wavelengths used for multiphoton excitation can reach deeper tissue layers due to reduced absorption and scattering. This is of particular importance for in vivo applications and especially in neuroscience where invasive tissue preparation for imaging access is preferably avoided.

In conventional laser-scanning nonlinear microscopy, the image is built by rapidly scanning a laser beam over the sample in a two-dimensional raster pattern using a pair of galvo mirrors. In such systems, to achieve good spatial resolution, the full numerical aperture (NA) of the excitation optic is used, and beam scanning is performed by changing the angle of incidence at the back aperture of the optic. It is desirable that the excitation optic maximizes two parameters simultaneously: high-NA focusing and large field-of-view (FOV) beam scanning coverage. The product of these parameters is constant for a given scanning system design akin to etendue, and thus a specific design may need to sacrifice FOV or NA. In other words, tight focusing may require high NA, but high NA limits the FOV because optical lens design limits the focusing performance at large off-axis angles. Accordingly, in conventional designs, achieving both large FOV and large NA may require physically large, heavy, and/or expensive objective lenses and associated assemblies. Similarly, other parts of the microscope must be large and heavy to rigidly support such a massive objective lens, which is often impractical.

### SUMMARY

According to one aspect of the disclosure, a nonlinear microscopy apparatus comprises a laser source coupled to a system base and a rotational optical assembly rotatably coupled to a microscope frame. The rotational optical assembly is configured to rotate relative to the microscope frame about an imaginary rotational axis. The rotational optical assembly includes a radial optical assembly that is translatable radially relative to the imaginary rotational axis. The rotational optical assembly comprises beam delivery optics configured to transmit a first laser beam generated by the laser source coincident with the rotational axis to the radial optical assembly. The radial optical assembly comprises an objective lens in optical communication with the rotational optical assembly and configured to focus the first laser beam to a focus point. In some embodiments, the nonlinear microscopy apparatus further comprises a detector coupled to the microscope frame and a beam splitter optically coupled to the laser source and the rotational optical assembly. The beam splitter is configured to direct the first laser beam to the rotational optical assembly and to direct secondary light received from the focus point through the rotational optical assembly to the detector. The detector is configured to generate a signal indicative of the secondary light received from the focus point through the rotational optical assembly.

In some embodiments the beam delivery optics comprise three or more reflective surfaces. In some embodiments, each reflective surface is included in a total internal reflection prism. In some embodiments, the beam delivery optics comprise a glass plate configured to rotate relative to the rotational optical assembly around an imaginary second rotational axis, wherein the second rotational axis is perpendicular to the rotational axis.

In some embodiments, the objective lens has a numerical aperture between 0.1 and 1. In some embodiments, the objective lens has numerical aperture greater than 0.4 or greater than 0.7.

In some embodiments, the nonlinear microscopy apparatus further comprises a controller coupled to the rotational optical assembly, the radial optical assembly, and the detector. The controller is configured to cause the rotational optical assembly to rotate; cause the radial optical assembly to translate radially from a first position relative to the imaginary rotational axis to a second position relative to the imaginary rotational axis while the rotational optical assembly rotates; capture first signal data indicative of the signal captured by the detector while the radial optical assembly translates from the first position to the second position; and convert the first signal data to two-dimensional image data or three-dimensional volume data. In some embodiments, to convert the first signal data to the two-dimensional image data or the three-dimensional volume data comprises to convert the first signal data to the two-dimensional image data by performing a polar coordinate to rectangular coordinate transformation on the first signal data. In some embodiments, the controller is further configured to maintain a predetermined optical energy deposition per unit area while the radial optical assembly translates. In some embodiments, to maintain the predetermined optical energy deposition comprises to increase repetition rate of the laser source while radial distance of the radial optical assembly relative to the imaginary optical axis increases, or to decrease rotation rate of the rotational optical assembly while radial distance of the radial optical assembly relative to the imaginary optical axis increases.

In some embodiments, to cause the radial optical assembly to translate radially comprises to displace the radial optical assembly by a predetermined step size for every rotation of the rotational optical assembly. In some embodiments, the step size is between 10 nm and 100 μm. In some embodiments, to cause the radial optical assembly to translate radially comprises to displace the radial optical assembly by a predetermined step size sequence based on rotation of the rotational optical assembly. In some embodiments, the controller is further configured to cause the microscope frame to translate relative to the system base in an axial direction along the rotational axis. In some embodiments, to cause the rotational optical assembly to rotate comprises to cause the optical assembly to rotate at a rotational frequency between 1 to 2000 Hz. In some embodiments, to cause the rotational optical assembly to rotate comprises to cause the optical assembly to rotate at a rotational frequency between 200 to 250 Hz. In some embodiments, the controller is further configured to actuate a divergence control unit of the laser source while the rotational optical assembly rotates; and to capture the first signal data further comprises to capture the first signal data while the divergence control unit is actuated to define a freeform focal surface that includes the focus point.

In some embodiments, the controller is further configured to cause a sample stage to translate from a third position to a fourth position after capturing the first signal data; cause the radial optical assembly to translate radially from the first position to the second position while the rotational optical assembly rotates after translation of the sample stage from the third position to the fourth position; capture second signal data indicative of the signal captured by the detector while the radial optical assembly translates from the first position to the second position after the translation of the sample stage from the third position to the fourth position; and combine the first signal data and the second signal data to generate the two-dimensional image data or the three-dimensional volume data. In some embodiments, to combine the first signal data and the second signal data comprises to position the first signal data and the second signal data as adjacent tiles. In some embodiments, to combine the first signal data and the second signal data comprises to overlap the first signal data and the second signal data with image registration. In some embodiments, the sample stage comprises a translation stage having at least two dimensions driven by a stepper motor or a DC motor.

In some embodiments, the controller is further configured to deactivate the detector after capturing the first signal data; and increase a power level of the laser source to an ablation power level after deactivation of the detector, wherein the ablation power level causes ablation of a target material at the focus point. In some embodiments, to deactivate the detector comprises to cause a shutter coupled to the detector to close. In some embodiments, to increase the power level comprises to maintain a wavelength of the laser source and increase a pulse energy of the laser beam. In some embodiments, the controller is further configured to cause the rotational optical assembly and the radial optical assembly to follow a first predetermined trajectory in response to an increase of the power level of the laser source to the ablation power level.

In some embodiments, the nonlinear microscopy apparatus further comprises a controller coupled to the rotational optical assembly, the radial optical assembly, and the detector, wherein the controller is configured to cause the rotational optical assembly to rotate; cause the radial optical assembly to hold at a first radial position relative to the imaginary rotational axis while the rotational optical assembly rotates; cause a sample stage to translate from a first position to a second position while the rotational optical assembly rotates; capture first signal data indicative of the signal captured by the detector while the sample stage translates from the first position to the second position with the radial optical assembly at the first radial position; and convert the first signal data to two-dimensional image data or three-dimensional volume data. In some embodiments, the first radial position comprises a maximum displacement of the radial optical assembly relative to the imaginary rotational axis. In some embodiments, the controller is further configured to track a current angular position of the rotational optical assembly, a current radial position of the radial optical assembly, and a current position of the sample stage during capture of the first signal data; wherein to convert the first signal data comprises to determine a pixel position for the image data based on the current angular position of the rotational optical assembly, the current radial position of the radial optical assembly, and the current position of the sample stage. In some embodiments, to convert the first signal data further comprises to identify first image data from a first pass of the rotational optical assembly at a first pixel position; identify second image data from a second pass of the rotational optical assembly at the first pixel position, wherein the second pass has an opposite direction from the first pass; and average the first image data and the second image data. In some embodiments, the controller is further configured to enable the laser source during a forward pass of the rotational optical assembly; and disable the laser source during a reverse pass of the rotational optical assembly. In some embodiments, the sample stage comprises translation stage having at least two dimensions driven by a stepper motor, a DC motor, or a linear motor.

In some embodiments, the radial optical assembly further comprises a reflective surface configured to direct the first laser beam from the beam delivery optics to the objective lens. In some embodiments, the radial optical assembly further comprises a plurality of reflective surfaces configured to direct the first laser beam from the beam delivery optics to the objective lens.

In some embodiments, the rotational optical assembly further comprises a counterbalance. In some embodiments, the counterbalance comprises a static counterbalance. In some embodiments, the counterbalance comprises a dynamic counterbalance configured to translate radially relative to the rotational axis synchronously with the radial optical assembly to rotationally balance the rotational optical assembly.

In some embodiments, the laser source comprises a mode locked solid state or fiber oscillator with a single laser beam, and wherein the single laser beam comprises a central wavelength in the range of 600 nm to 2200 nm; a pulse energy in the range of 1 nJ to 1000 nJ; a repetition rate in the range of 1 kHz to 100 MHz; and a pulse duration in the range of 10 femtoseconds to 50 picoseconds. In some embodiments, the laser source comprises a mode locked solid state or fiber oscillator with a nonlinear conversion unit and at least one laser beam, wherein each of the laser beams comprises a central wavelength in the range of 200 nm to 20,000 nm; a pulse energy in the range of 1 nJ to 1000 nJ; a repetition rate in the range of 1 kHz to 100 MHz; and a pulse duration in the range of 10 femtoseconds to 50 picoseconds. In some embodiments, the laser source comprises a mode locked solid state or fiber oscillator with an optical amplifier with a single laser beam, wherein the single laser beam comprises a central wavelength in the range of 600 nm to 2200 nm; a pulse energy in the range of 1 nJ to 1 mJ; a repetition rate in the range of 1 kHz to 100 MHz; and a pulse duration in the range of 10 femtoseconds to 50 picoseconds. In some embodiments, the laser source comprises a mode locked solid state or fiber oscillator with an optical amplifier with a nonlinear conversion unit and at least one laser beam, wherein each of the laser beams comprises a central wavelength in the range of 200 nm to 20,000 nm; a pulse energy in the range of 1 nJ to 1 mJ; a repetition rate in the range of 1 kHz to 100 MHz; and a pulse duration in the range of 10 femtoseconds to 50 picoseconds.

In some embodiments, the nonlinear microscopy apparatus further comprises a beam conditioning unit that comprises a pulse modulation unit having a modulation speed of up to 100 MHz. In some embodiments, the nonlinear microscopy apparatus further comprises a beam conditioning unit that comprises a laser beam divergence control unit having a divergence control speed of up to 2 kHz. In some embodiments, the nonlinear microscopy apparatus further comprises a beam conditioning unit that comprises a laser beam polarization control unit configured to rotate linear polarization state or generate an arbitrary polarization state. In some embodiments, the nonlinear microscopy apparatus further comprises a beam conditioning unit that comprises a pulse delay control unit configured to adjust a delay between at least two laser beams, wherein the delay ranges from 0 femtoseconds to 50 picoseconds. In some embodiments, the nonlinear microscopy apparatus further comprises a beam conditioning unit that comprises a beam pointing control unit configured to control the position and directionality of at least one laser beam.

In some embodiments, the nonlinear microscopy apparatus further comprises a fiber delivery unit that couples at least the first laser beam to an optical fiber, wherein the optical fiber is guided to the beam delivery optics. In some embodiments, the nonlinear microscopy apparatus further comprises a beam conditioning unit mechanically coupled to the laser source or to the system base. In some embodiments, the laser source comprises a beam conditioning unit. In some embodiments, the beam delivery optics and the objective lens comprise reflective or transmissive optics.

In some embodiments, wherein the detector is configured to detect the secondary light in epi-configuration, wherein the secondary light originates from a sample and is transmitted through or reflected by at least the objective lens and the beam delivery optics. In some embodiments, the detector is configured to detect the secondary light in in trans-configuration, wherein the secondary light originates from a sample at the focus point and is transmitted through or reflected by at least a collection lens other than the objective lens. In some embodiments, the secondary light originates in at least one process of multi-photon absorption induced fluorescence, second harmonic generation, third harmonic generation, stimulated Raman scattering, coherent anti-Stokes Raman scattering, linear absorption, reflectance, or single-photon induced fluorescence. In some embodiments, the detector is configured to detect a fluorescence lifetime or an emission spectrum of the secondary light.

In some embodiments, the microscope frame is coupled to the system base. In some embodiments, the microscope frame is movable relative to the system base. In some embodiments, the nonlinear microscopy apparatus further comprises an optical fiber. The optical fiber optically couples the laser source of the system base to the beam delivery optics of the rotational optical assembly. In some embodiments, the optical fiber comprises a solid-core photonic crystal, a hollow-core photonic crystal, a negative curvature optical fiber, an anti-resonant fiber design, or a photonic bandgap fiber design. In some embodiments, the nonlinear microscopy apparatus further comprises an articulated arm that couples the system base and the microscope frame. The articulated arm is configured to transmit the first laser beam to the beam delivery optics of the rotational optical assembly. In some embodiments, the articulated arm comprises a rotational joint and a mirror at the rotational joint configured to change a direction of the laser beam. In some embodiments, the articulated arm further comprises a variable-length segment coupled to the rotational joint. In some embodiments, the nonlinear microscopy apparatus further comprises a mechanical support coupled to the microscope frame. In some embodiments, the mechanical support comprises a preloaded spring, a compressed gas cylinder, or an actively controlled servo motor.

In some embodiments, the focus point is positioned below the microscope frame, and the first laser beam reaches the focus point from above a nominal sample plane. In some embodiments, the focus point is positioned above the microscope frame and the first laser beam reaches the focus point from below a nominal sample plane.

According to another aspect, a method for nonlinear microscopy comprises causing, by a controller, a rotational optical assembly to rotate about an imaginary rotational axis, wherein the rotational optical assembly is rotatably coupled to a microscope frame and includes a radial optical assembly that is translatable radially relative to the imaginary rotational axis, wherein the rotational optical assembly comprises beam delivery optics configured to transmit a first laser beam generated by a laser source coincident with the rotational axis to the radial optical assembly, and wherein the radial optical assembly comprises an objective lens in optical communication with the rotational optical assembly and configured to focus the first laser beam to a focus point; causing, by the controller, the radial optical assembly to translate radially from a first position relative to the imaginary rotational axis to a second position relative to the imaginary rotational axis while the rotational optical assembly rotates; capturing, by the controller, first signal data indicative of a signal captured by a detector while the radial optical assembly translates from the first position to the second position, wherein the detector is coupled to the microscope frame and is configured to generate a signal indicative of the secondary light received from the rotational optical assembly; and converting, by the controller, the first signal data to two-dimensional image data or three-dimensional volume data.

In some embodiments, converting the first signal data to the two-dimensional image data or the three-dimensional volume data comprises converting the first signal data to the two-dimensional image data by performing a polar coordinate to rectangular coordinate transformation on the first signal data.

In some embodiments, the method further comprises maintaining, by the controller, a predetermined optical energy deposition per unit area while the radial optical assembly translates. In some embodiments, maintaining the predetermined optical energy deposition comprises increasing repetition rate of the laser source while radial distance of the radial optical assembly relative to the imaginary optical axis increases, or decreasing rotation rate of the rotational optical assembly while radial distance of the radial optical assembly relative to the imaginary optical axis increases.

In some embodiments, causing the radial optical assembly to translate radially comprises displacing the radial optical assembly by a predetermined step size for every rotation of the rotational optical assembly. In some embodiments, the step size is between 10 nm and 100 μm. In some embodiments, causing the radial optical assembly to translate radially comprises displacing the radial optical assembly by a predetermined step size sequence based on rotation of the rotational optical assembly. In some embodiments, the method further comprises causing, by the controller, the objective lens to translate in an axial direction along the rotational axis. In some embodiments, causing the rotational optical assembly to rotate comprises causing the optical assembly to rotate at a rotational frequency between 1 to 2000 Hz. In some embodiments, causing the rotational optical assembly to rotate comprises causing the optical assembly to rotate at a rotational frequency between 200 to 250 Hz. In some embodiments, the method further comprises actuating, by the controller, a divergence control unit of the laser source while the rotational optical assembly rotates; wherein capturing the first signal data further comprises capturing the first signal data while the divergence control unit is actuated to define a freeform focal surface that includes the focus point.

In some embodiments, the method further comprises causing, by the controller, a sample stage to translate from a third position to a fourth position after capturing the first signal data; causing, by the controller, the radial optical assembly to translate radially from the first position to the second position while the rotational optical assembly rotates after translating the sample stage from the third position to the fourth position; capturing, by the controller, second signal data indicative of the signal captured by the detector while the radial optical assembly translates from the first position to the second position after translating the sample stage from the third position to the fourth position; and combining, by the controller, the first signal data and the second signal data to generate the two-dimensional image data or the three-dimensional volume data. In some embodiments, combining the first signal data and the second signal data comprises positioning the first signal data and the second signal data as adjacent tiles. In some embodiments, combining the first signal data and the second signal data comprises overlapping the first signal data and the second signal data with image registration. In some embodiments, the sample stage comprises a translation stage having at least two dimensions driven by a stepper motor or a DC motor.

In some embodiments, the method further comprises deactivating, by the controller, the detector after capturing the first signal data; and increasing, by the controller, a power level of the laser source to an ablation power level after deactivating the detector, wherein the ablation power level causes ablation of a target material at the focus point. In some embodiments, deactivating the detector comprises causing a shutter coupled to the detector to close. In some embodiments, increasing the power level comprises maintaining a wavelength of the laser source and increasing a pulse energy of the laser beam. In some embodiments, the method further comprises causing, by the controller, the rotational optical assembly and the radial optical assembly to follow a first predetermined trajectory in response to increasing the power level of the laser source to the ablation power level.

In some embodiments, the beam delivery optics comprise three or more reflective surfaces. In some embodiments, each reflective surface is included in a total internal reflection prism. In some embodiments, the objective lens has a numerical aperture between 0.1 and 1. In some embodiments, the objective lens has numerical aperture greater than 0.4 or greater than 0.7.

In some embodiments, the radial optical assembly further comprises a reflective surface configured to direct the first laser beam from the beam delivery optics to the objective lens. In some embodiments, the radial optical assembly further comprises a plurality of reflective surfaces configured to direct the first laser beam from the beam delivery optics to the objective lens.

In some embodiments, the rotational optical assembly further comprises a counterbalance. In some embodiments, the counterbalance comprises a static counterbalance. In some embodiments, the counterbalance comprises a dynamic counterbalance, the method further comprising causing, by the controller, the dynamic counterbalance to translate radially relative to the rotational axis synchronously with the radial optical assembly to rotationally balance the rotational optical assembly.

In some embodiments, the laser source comprises a mode locked solid state or fiber oscillator with a single laser beam, and wherein the single laser beam comprises a central wavelength in the range of 600 nm to 2200 nm; a pulse energy in the range of 1 nJ to 1000 nJ; a repetition rate in the range of 1 kHz to 100 MHz; and a pulse duration in the range of 10 femtoseconds to 50 picoseconds. In some embodiments, the laser source comprises a mode locked solid state or fiber oscillator with a nonlinear conversion unit and at least one laser beam, wherein each of the laser beams comprises a central wavelength in the range of 200 nm to 20,000 nm; a pulse energy in the range of 1 nJ to 1000 nJ; a repetition rate in the range of 1 kHz to 100 MHz; and a pulse duration in the range of 10 femtoseconds to 50 picoseconds. In some embodiments, the laser source comprises a mode locked solid state or fiber oscillator with an optical amplifier with a single laser beam, wherein the single laser beam comprises a central wavelength in the range of 600 nm to 2200 nm; a pulse energy in the range of 1 nJ to 1 mJ; a repetition rate in the range of 1 kHz to 100 MHz; and a pulse duration in the range of 10 femtoseconds to 50 picoseconds. In some embodiments, the laser source comprises a mode locked solid state or fiber oscillator with an optical amplifier with a nonlinear conversion unit and at least one laser beam, wherein each of the laser beams comprises a central wavelength in the range of 200 nm to 20,000 nm; a pulse energy in the range of 1 nJ to 1 mJ; a repetition rate in the range of 1 kHz to 100 MHz; and a pulse duration in the range of 10 femtoseconds to 50 picoseconds.

In some embodiments, the laser source comprises a pulse modulation unit having a modulation speed of up to 100 MHz. In some embodiments, the laser source comprises a laser beam divergence control unit having a divergence control speed of up to 2 kHz. In some embodiments, the laser source comprises a laser beam polarization control unit configured to rotate linear polarization state or generate an arbitrary polarization state. In some embodiments, the laser source comprises a pulse delay control unit configured to adjust a delay between at least two laser beams, wherein the delay ranges from 0 femtoseconds to 50 picoseconds. In some embodiments, the laser source comprises a beam pointing control unit configured to control the position and directionality of at least one laser beam.

In some embodiments, the laser source comprises a fiber delivery unit that couples at least the first laser beam to an optical fiber, wherein the optical fiber is guided to the beam delivery optics. In some embodiments, the beam delivery optics and the objective lens comprise reflective or transmissive optics.

In some embodiments, the detector is configured to detect the secondary light in epi-configuration, wherein the secondary light originates from a sample and is transmitted through or reflected by at least the objective lens and the beam delivery optics. In some embodiments, the detector is configured to detect the secondary light in in trans-configuration, wherein the secondary light originates from a sample at the focus point and is transmitted through or reflected by at least a collection lens other than the objective lens. In some embodiments, the secondary light originates in at least one process of multi-photon absorption induced fluorescence, second harmonic generation, third harmonic generation, stimulated Raman scattering, coherent anti-Stokes Raman scattering, linear absorption, reflectance, or single-photon induced fluorescence. In some embodiments, the detector is configured to detect a fluorescence lifetime or an emission spectrum of the secondary light.

According to another aspect, a method for nonlinear microscopy comprises causing, by a controller, a rotational optical assembly to rotate about an imaginary rotational axis, wherein the rotational optical assembly is rotatably coupled to a microscope frame and includes a radial optical assembly that is translatable radially relative to the imaginary rotational axis, wherein the rotational optical assembly comprises beam delivery optics configured to transmit a first laser beam generated by a laser source coincident with the rotational axis to the radial optical assembly, and wherein the radial optical assembly comprises an objective lens in optical communication with the rotational optical assembly and configured to focus the first laser beam to a focus point; causing, by the controller, the radial optical assembly to hold at a first radial position relative to the imaginary rotational axis while the rotational optical assembly rotates; causing, by the controller, a sample stage to translate from a first position to a second position while the rotational optical assembly rotates; capturing, by the controller, first signal data indicative of a signal captured by a detector while the sample stage translates from the first position to the second position with the radial optical assembly at the first radial position, wherein the detector is coupled to the microscope frame and is configured to generate a signal indicative of the secondary light received from the rotational optical assembly; and converting, by the controller, the first signal data to two-dimensional image data or three-dimensional volume data.

In some embodiments, the first radial position comprises a maximum displacement of the radial optical assembly relative to the imaginary rotational axis. In some embodiments, the method further comprises tracking, by the controller, a current angular position of the rotational optical assembly, a current radial position of the radial optical assembly, and a current position of the sample stage while capturing the first signal data; wherein converting the first signal data comprises determining a pixel position for the image data based on the current angular position of the rotational optical assembly, the current radial position of the radial optical assembly, and the current position of the sample stage. In some embodiments, converting the first signal data further comprises identifying first image data from a first pass of the rotational optical assembly at a first pixel position; identifying second image data from a second pass of the rotational optical assembly at the first pixel position, wherein the second pass has an opposite direction from the first pass; and averaging the first image data and the second image data. In some embodiments, the method further comprises enabling, by the controller, the laser source during a forward pass of the rotational optical assembly; and disabling, by the controller, the laser source during a reverse pass of the rotational optical assembly. In some embodiments, the sample stage comprises a translation stage having at least two dimensions driven by a stepper motor, a DC motor, or a linear motor.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1A is a schematic illustration of an example nonlinear microscopy apparatus;

FIG. 1B is a schematic illustration of another example nonlinear microscopy apparatus;

FIG. 1C is a schematic illustration of another example nonlinear microscopy apparatus;

FIG. 2 is a schematic illustration of a scanning route view that may be accessed using the nonlinear microscopy apparatus of any of FIGS. 1A-1C;

FIG. 3 is a block diagram of at least one illustrative embodiment of a nonlinear microscopy apparatus of FIGS. 1A-1C;

FIG. 4 is a schematic diagram of the illustrative nonlinear microscopy apparatus of FIG. 3;

FIGS. 5 and 6 are example microscope images generated by a nonlinear microscopy apparatus of FIGS. 1A-4;

FIGS. 7-11 are schematic diagrams illustrating detector configurations that may be used with a nonlinear microscopy apparatus of FIGS. 1A-4;

FIGS. 12A-12B are schematic illustrations of additional example nonlinear microscopy apparatuses with decoupled laser heads and scanner units; and

FIG. 13 is a schematic illustration of an additional example nonlinear microscopy apparatus in an inverted configuration.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

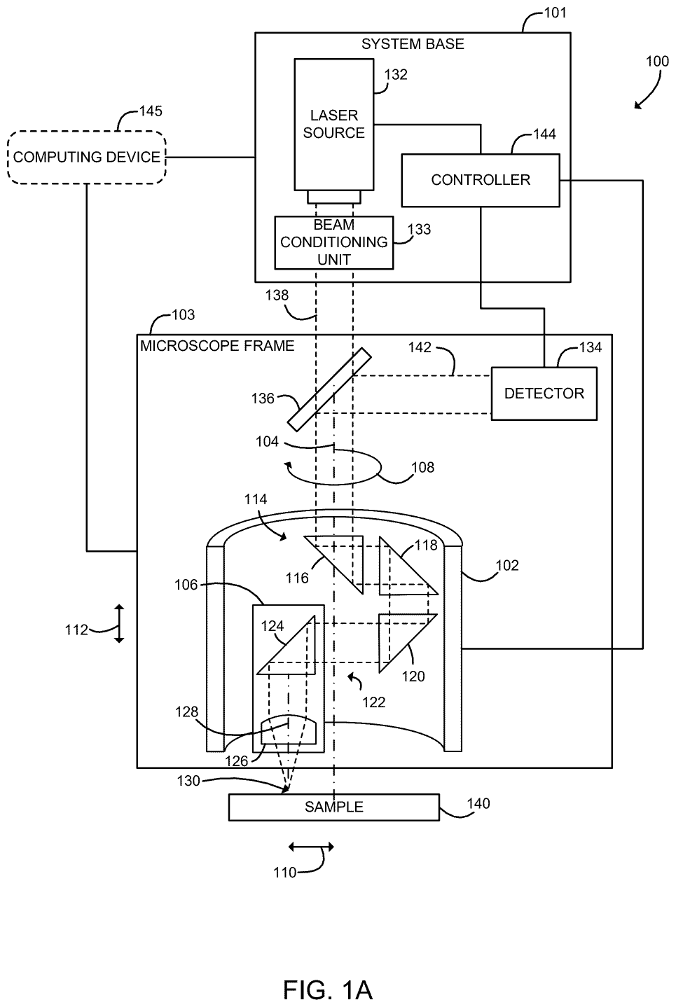

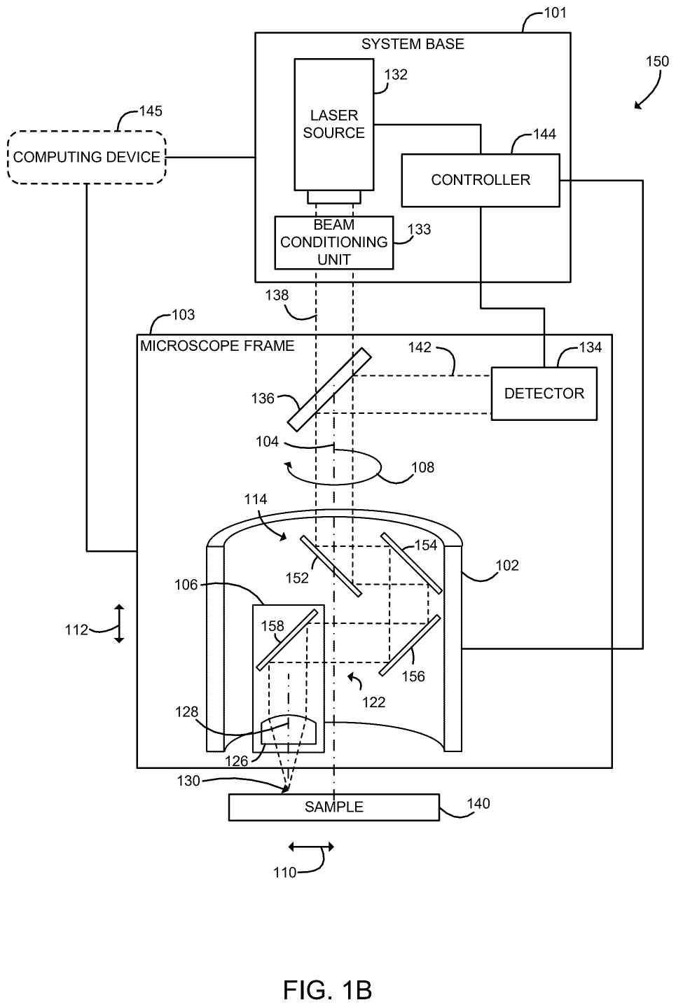

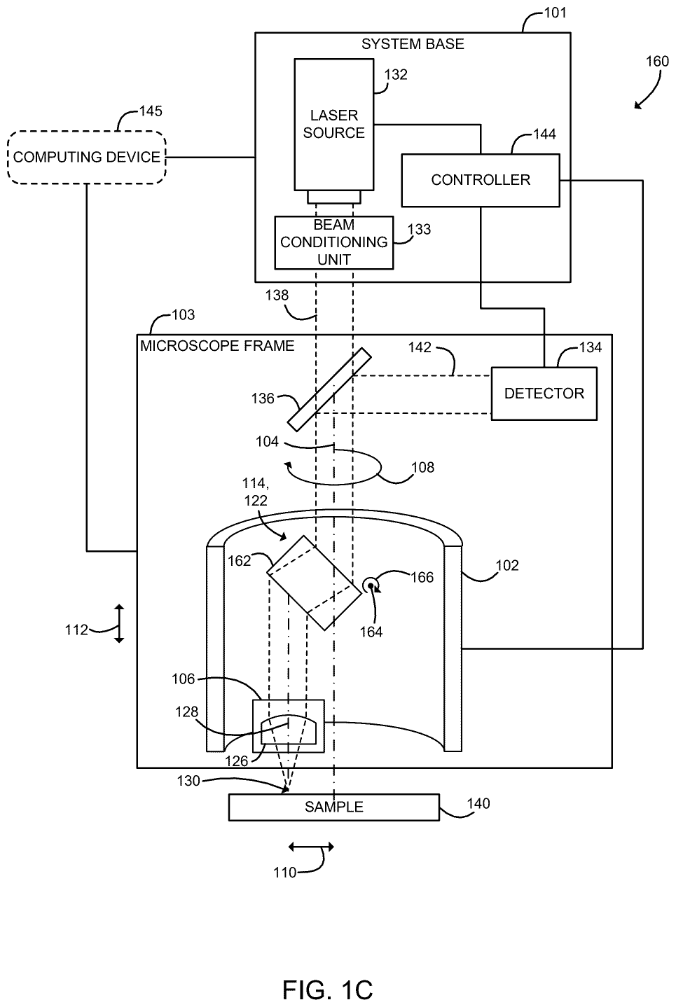

Referring now to FIG. 1A, an example embodiment of a device 100 for a scanning assembly for nonlinear microscopy is shown. In operation, as described further below, a rotational optical assembly 102 rotates about an imaginary rotational axis 104, and while the rotational optical assembly 102 rotates, a radial optical assembly 106 is translated radially relative to the rotational axis 104. During this motion, laser light is transmitted via beam delivery optics and focusing optics through the rotational optical assembly 102 and the radial optical assembly 106 to a sample, thus tracing a spiral pattern (or any other curve that can be defined by radial distance and angle over time, r(t), θ(t)) over the sample. Secondary light generated by the sample is transmitted back through the focusing optics and the beam delivery optics to a detector (or, in some embodiments, forward through collector optics to the detector, sideways by an off-axis parabolic reflector, or in another direction), which may be used to generate one or more images of the sample. Accordingly, the device 100 is capable of generating microscopic images of the sample by mechanically scanning the laser beam over the sample. This allows the device 100 to achieve both a relatively large field of view (FOV) and a relatively large numerical aperture (NA) without requiring the use of a large, expensive, custom-made, unavailable, or otherwise unusual focusing lens.

Therefore, the disclosure herein solves the trade-off between high-NA focusing and a large-FOV by decoupling the roles of focusing and scanning. As described above, a focusing lens is placed at the end of a fast optomechanical scanner, which allows the lens to be moved over the sample while keeping the laser beam on the axis of the lens. The lens can thus be made much smaller while keeping a relatively high-NA and solely on-axis operation significantly simplifies the optical design of a suitable lens as well as minimizes its size, weight and cost. The mechanical scanning system moves the lens while relaying the beam. As a result the maximum FOV may be determined by the travel radius of the lens rather than by its optical design. Furthermore, from the standpoint of the lens, all image points are on-axis and thus there is no off-axis deterioration in resolution or vignetting. As an illustrative example, at least one illustrative embodiment of the disclosure can reach an FOV diameter of 10 mm at a diffraction-limited resolution 0.4 μm in XY and 1.8 μm in Z with a 0.6 NA optic, and 0.2 μm in XY and 1 μm in Z with a 0.8 NA optic.

Additionally, in some embodiments the disclosure herein may employ multifocal scanning to increase scanning speed. In some embodiments, the beam reaching the movable objective lens may be used not necessarily on-axis only. In those embodiments, two or more beamlets separated by angle or position may be used to draw two or more trajectories, thus increasing pixel scanning throughput by a factor of two or more. Beam multiplexing can be achieved, for example, by fast acoustooptic, electrooptic, or resonant scanning, while signal demultiplexing can be achieved by detector separation, polarization, or temporal demultiplexing. The on-axis geometry in the disclosed scanner simplifies multiplexing and demultiplexing significantly in that the lens numerical aperture and beamlet separation angle are separate from the scanning field of view coverage, in contrast to traditional scanning systems where beam scanning and angular/position multiplexing are intertwined at the same lens, which complicates the design.

The small weight of the scanning lens in divergence control unit combined with the on-axis geometry disclosed herein allows for fast axial focal plane adjustment, because the focusing element only needs to shift the focus of a stationary beam while the mechanical scanning system performs lateral scanning. This is in contrast to mechanical scanning of the imaging lens supporting a large FOV, which prevents the systems from being small and light enough to be translated at a high speed. Remote focusing schemes exist that separate lateral and axial focus scanning units and allow for fast axial scanning, but usually at the expense of the available FOV as the axial scan extent increases. With entirely separate means of axial and lateral scanning as disclosed herein, the axial scanning range and speed can be significantly increased and the entire scanning unit can perform high-aspect-ratio three-dimensional spiral scans. It is estimated that with an axial focuser movement of 1.5 kHz and scanner rotation of 500 Hz, spirals of aspect ratios of 1:3 (XY/Z) can be achieved—that is, spirals that are three times as deep in the axial direction compared to their lateral extent.

In some embodiments, a lens, an achromatic lens, a pair of mirrors, or a pair of curved mirrors can be used for axial scanning.

Further, the scanner disclosed herein may be quite effective at collecting light. Large-aperture objectives as in conventional scanners are good at collecting strongly scattered light that exits the sample further away from the center of the FOV. A smaller aperture objective would not be as efficient at large FOVs and introduce vignetting. However, a smaller lens that is always just at the right position as disclosed herein is also effective at collecting light from the sample. Furthermore a movable lens having the same NA would even be more efficient compared to a conventional imaging objective lens because it would have fewer optical surfaces and thus a higher transmission.

Maximum NA for a spiral scanner as disclosed herein may be somewhat limited by the minimum working distance of the system. In particular, the moving lens scanner as disclosed herein may be used for ex and in vivo applications, including but not limited to live tissue imaging such as dermatology, ophthalmology applications or other clinical applications, or research applications. Other applications may include tissue biopsies, High-Throughput Screening (HTS), in-vitro models, cell cultures, work as a microplate reader, ELISA (Enzyme-Linked Immunosorbent Assay), liposomes, and/or vesicles. In those embodiments, the fast-moving optic of the spiral scanner should be kept some distance away from the sample surface. Careful engineering and safety systems can still achieve NA up to 1.0. Higher NA may be achieved with immersion for stationary lenses and perhaps with moving lenses as described herein. In some embodiments, acoustical noise from the disclosed mechanical scanning system may be advantageously reduced for certain applications (e.g., live animal imaging), for example with acoustical isolation or other acoustical engineering.

Referring again to FIG. 1A, as discussed above, the nonlinear microscopy device 100 includes the rotational optical assembly 102 and the radial optical assembly 106. Each of the rotational optical assembly 102 and the radial optical assembly 106 may be embodied as one or more frames, shells, armatures, or other mechanical components configured to support one or more included optical elements as described further below. As shown, the microscopy device 100 includes a system base 101, which may include one or more stationary mechanical components configured to support other components of the device 100. The system base 101 is mechanically coupled to a microscope frame 103, which may be movable in a focusing direction relative to the system base 101, as described further below. The rotational optical assembly 102 may be further rotatably coupled to the microscope frame 103 or other structure using one or more bearings or other mechanical connections.

As shown in FIG. 1A, the rotational optical assembly 102 is configured to rotate about the rotational axis 104 as indicated by angle of rotation 108. As described further below, the rotational optical assembly may be rotated at a constant rotational speed (or frequency) or a variable rotational speed (or frequency). For example, in an embodiment the rotational optical assembly 102 may be rotated at a rotational frequency between 1 and 5,000 Hz. In other embodiments the rotational optical assembly 102 may be rotated at a rotational frequency up to 2,000 Hz, at a rotational frequency up to 500 Hz, at a rotational frequency between 100 and 400 Hz, at a rotational frequency between 200 and 250 Hz, or at another speed. In some embodiments, the rotational optical assembly 102 may be rotated at rotational frequencies up to about 500 Hz with any given acceleration or deceleration curve, and the minimum rotational frequency may be as low as 0.1 Hz. In addition to the optical components described further below, the rotational optical assembly 102 may include one or more moveable counterweights and/or other mechanical components configured to provide balanced rotation at a constant or otherwise controllable rotational speed. For example, in some embodiments, the rotational optical assembly 102 may include a dynamic counterbalance that translates radially relative to the rotational axis 104 synchronously with the radial optical assembly 106, in order to balance rotational forces of the rotational optical assembly 102.

The radial optical assembly 106 is coupled to the rotational optical assembly 102 and rotates with the rotational optical assembly 102 about the rotational axis 104. The radial optical assembly 106 is further configured to translate in a radial direction relative to the rotational axis 104. As shown, the radial optical assembly 106 may be positioned at a radial distance 110 from the rotational axis 104, and that radial distance 110 may be varied independently over time as the rotational optical assembly 102 rotates. Accordingly, and as described further below, the radial optical assembly 106 may trace a spiral path relative to the rotational axis 104. In some embodiments, the radial optical assembly 106 may be translated radially in a stepwise fashion by a predetermined step size, for example using one or more stepper motors. As another example, the radial optical assembly 106 may be translated radially using a servo, angle-controlled brushless DC (BLDC) motor. For example, the radial distance 110 may be increased by one step for 16000 times per rotation of the rotational optical assembly 102. Determination of the rotation of the rotational optical assembly 102 may be determined using an encoder or other rotational position sensor, and step size and/or step rate may be based on resolution of the encoder. In some embodiments, the step size may be between 10 nm and 100 μm. For example, in an embodiment, the radial distance 110 may range from 0.0 to 10.3 mm with 0.05 μm per step. Additionally or alternatively, in some embodiments, the radial optical assembly 106 may be translated by a predetermined sequence of step sizes based on rotation of the rotational optical assembly 102.

The radial optical assembly 106 or, in some embodiments, one or more optical components of the radial optical assembly 106 may be further moveable in an axial direction relative to the rotational axis 104, also called a focusing direction. As shown, a focusing distance 112 may be varied independently from radial distance 110 and angle 108 to change focusing depth of the microscopy device 100. For example, in an embodiment the focusing distance 112 may range from 0.0 to 4.0 mm in air with 0.1 μm per step. In such embodiments, focusing distance 112 may be controlled using direct drive rather than a stepper motor. In some embodiments, one or more of the radial distances 110, the focusing distance 112, and the rotational angle 108 may be varied simultaneously, allowing the microscopy device 100 to scan the focal spot over a freeform, arbitrary focal surface rather than just in a flat plane. In the illustrative embodiment, the focusing distance 112 is adjusted by moving the microscope frame 103 relative to the stationary system base 101 in the focusing direction.

The rotational optical assembly 102 and the radial optical assembly 106 further include multiple optical components configured to deliver one or more laser beams to a sample and to collect secondary light generated by that sample. In particular, the rotational optical assembly 102 includes beam delivery optics 114 configured to deliver one or more input laser beams to the radial optical assembly 106 and to collect signals from assembly 106 back to the input port of the rotational assembly 102. In the illustrated embodiment, the beam delivery optics 114 include three total internal reflection prisms 116, 118, 120 configured to transmit and reflect light incident along the rotational axis 104 to the radial optical assembly 106 (and back). Similarly, the radial optical assembly 106 includes beam delivery optics 122, illustratively a total internal reflection prism 124, configured to deliver one or more laser beams received from the beam delivery optics 114 to an objective lens 126 (and back). In other embodiments, the beam delivery optics 114, 122 may include one or more mirrors, lenses, and/or other optical elements configured to appropriately transmit and/or reflect light. For example, in one embodiment, each of the total internal reflection prisms may be replaced with a flat mirror as a reflective element. In that embodiment, the beam delivery optics 122 may include an objective lens 126 as a focusing element. One such embodiment including flat mirror elements is described below in connection with FIG. 1B. As another example, in one embodiment, the beam delivery optics 122 may include a single non-flat mirror that both directs and focuses the beam to the sample.

As yet another example, in an embodiment multiple excitation beam 138 delivery may be angle-multiplexed to increase imaging speed. In such embodiments, multiple excitation beams 138 (e.g., three or more) are created with an additional optical element such as a diffractive beam splitter or wedges. This additional optical element is positioned in the excitation beam 138 path before the dichroic separation mirror 136. The additional optical element may be positioned on an additional scanning unit (i.e., an additional rotational assembly) that may be used to synchronize angle with the rotational optical assembly 102. By controlling angle phase of the additional scanning unit, multiple foci 130 may be maintained in-line at any given angle 108, radial distance 110, and z-distance 112. Accordingly, in such embodiments, multiple foci 130 of the excitation beams 138 are perpendicular to the rotation axis and positioned in-line at any given configuration 108, 110, 112.

Referring again to FIG. 1A, the objective lens 126 may be embodied as a relatively high-NA lens configured to converge laser light on to a focus point 130, and to collect secondary light generated at the focus point 130. As shown, the objective lens 126 may define an optical axis 128 that is parallel to the rotational axis 104 and offset by the radial distance 110. Accordingly, light transmitted through the objective lens 126 may be close to being on-axis. This largely on-axis operation allows the objective lens 126 to have a relatively high NA while maintaining a relatively simple design, small size, mass, and/or cost. Illustratively, in an embodiment the objective lens 126 may have an NA of 0.6, of 0.8, or an NA within a range of 0.1 to 1.0. For example, in an embodiment, the objective lens 126 has an NA of 0.41 with an effective focal length of 6.7 mm. That objective lens 126 may be exchanged with a different lens having the same diameter but a different NA, such as a lens with NA of 0.7 and effective focal length of 3.1 mm. Although illustrated as a lens, it should be understood that in some embodiments the lens may be replaced with one or more mirrors or other appropriate beam focusing elements.

As shown in FIG. 1A, the microscopy device 100 further includes a laser source 132, an optical detector 134, and a beam splitter 136, each of which may be coupled to the system base 101 and/or the microscope frame 103 frame or otherwise fixed relative to the axis of rotation 104 and thus the rotational optical assembly 102. The laser source 102 may be embodied as a short-pulse laser source, such as a femtosecond laser source. For example, the laser source 102 may be embodied as a mode-locked solid state or fiber oscillator with a single laser beam having a central wavelength in the range of 600 nm to 2200 nm, a pulse energy in the range of 1 nJ to 1000 nJ, a repetition rate in the range of 1 kHz to 100 MHZ, and a pulse duration in the range of 10 femtoseconds to 50 picoseconds. As another example, the laser source 132 may be embodied as a mode-locked solid-state or fiber oscillator with a nonlinear conversion unit and at least one laser beam, each laser beam having a central wavelength in the range of 200 nm to 20,000 nm, a pulse energy in the range of 1 nJ to 1000 nJ, a repetition rate in the range of 1 kHz to 100 MHZ, and a pulse duration in the range of 10 femtoseconds to 50 picoseconds. As yet another example, the laser source 132 may be embodied as a mode-locked solid-state or fiber oscillator with an optical amplifier with a single laser beam having a central wavelength in the range of 600 nm to 2200 nm, a pulse energy in the range of 1 nJ to 1 mJ, a repetition rate in the range of 1 kHz to 100 MHz, and a pulse duration in the range of 10 femtoseconds to 50 picoseconds. As still yet another example, the laser source 132 may be embodied as a mode-locked solid-state or fiber oscillator with an optical amplifier with a nonlinear conversion unit and at least one laser beam, each laser beam having a central wavelength in the range of 200 nm to 20,000 nm, a pulse energy in the range of 1 nJ to 1 mJ, a repetition rate in the range of 1 kHz to 100 MHZ, and a pulse duration in the range of 10 femtoseconds to 50 picoseconds.

The microscopy device 100 may further include a beam conditioning unit 133 optically coupled to the laser source 132. The beam conditioning unit 133 may be mechanically attached to the system base 101. The beam conditioning unit 133 may include one or more divergence control units, nonlinear conversion units, optical amplifiers, pulse modulation units, pulse pickers, polarization control units, pulse delay control units, beam pointing control units, and/or other beam conditioning components. For example, the beam conditioning unit 133 may include a pulse modulation unit having a modulation speed of up to 100 MHz; a laser beam divergence control unit having a divergence control speed of up to 2 kHz; a laser beam polarization control unit configured to rotate linear polarization state or generate an arbitrary polarization state; a pulse delay control unit configured to adjust a delay between multiple laser beams (e.g., from 0 femtoseconds to 50 picoseconds); and/or a beam pointing control unit configured to control the position and directionality of at least one laser beam. In some embodiments, the beam conditioning unit 133 and/or one or more subcomponents of the beam conditioning unit 133 may be included in the laser source 132 or otherwise have their functions performed by the laser source 132.

The optical detector 134 is configured to generate a signal indicative of light received by the detector 134. In some embodiments, the detector 134 may be a broadband detector configured to detect multiple wavelengths of light and/or may include multiple sub-detectors that are each configured to detect one or more wavelengths or ranges of wavelengths of light. In an embodiment, the detector 134 may detect nonlinear signals, including MPEF at one or more distinct spectral bands, THG, and/or SHG. In some embodiments, the detector 134 may detect signals such as a fluorescence lifetime or an emission spectrum of received light.

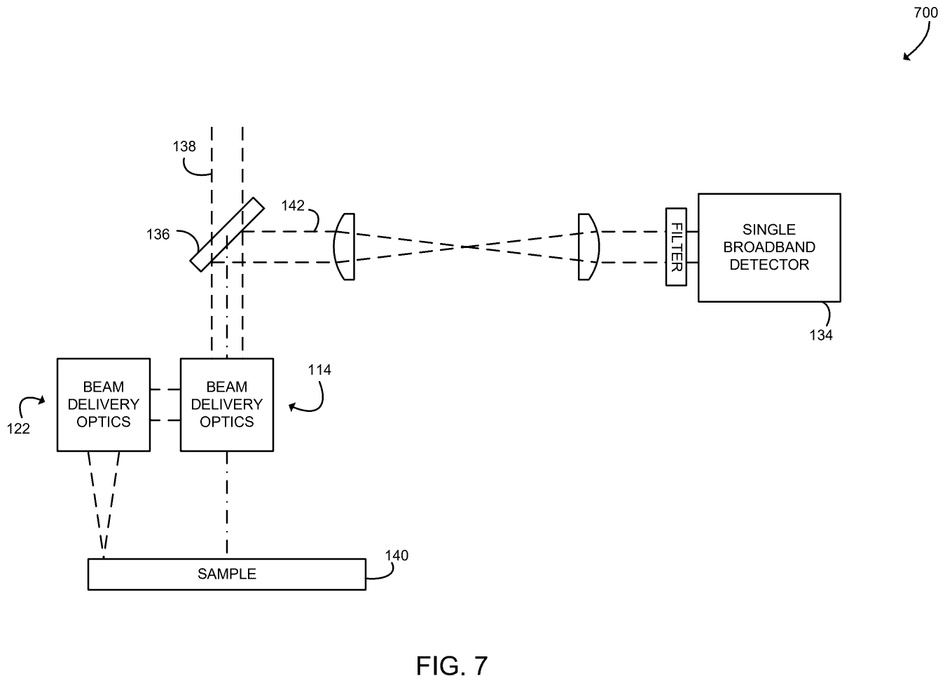

The beam splitter 136 is positioned between the laser source 132, the detector 134, and the rotational optical assembly 102. The beam splitter 136 may be embodied as, for example, a dichroic separation mirror, a longpass mirror, or other optical element configured to separation excitation laser light from emission light. As shown, the beam splitter 136 is configured to allow laser light 138 generated by the laser source 132 to pass through to the rotational optical assembly 102. The laser light 138 is directed by the beam delivery optics 114, 122 to the objective lens 126, which focuses the laser light 138 to the focus point 130. Although illustrated as being directed from the laser source 132 to the beam delivery optics 114 through free space, in some embodiments the laser light 138 may be directed with one or more optical fibers, fiber delivery units, or other transmission systems that couple the laser light 138 to the beam delivery optics 140. A sample 140 is positioned at the focus point 130. The sample 140 may be embodied as a tissue sample, an in vivo sample, or any other sample to be imaged by the microscopy device 100. The sample 140 may be supported by a three-dimensional XYZ stage or other adjustable stage (not shown). Multiphoton optical interaction causes the sample 140 to generate secondary light 142, which is collected by the objective lens 126 and transmitted via the beam delivery optics 122, 114 out of the rotational optical assembly 102 to the beam splitter 136. The beam splitter 136 directs the secondary light 142 to the detector 134, which generates one or more signals indicative of the received secondary light 142. Additional configurations of the beam splitter 136 and/or detector 134 are shown in FIGS. 7-11 and described further below.

The microscopy device 100 further includes or is otherwise coupled to a controller 144. The controller 144 may be coupled to the laser source 132, the detector 134, the rotational optical assembly 102, and/or the radial optical assembly 106. The controller 144 may be configured to control rotation of the rotational optical assembly 102 and to control translation of the radial optical assembly 106. The controller 144 may be further configured to control operation of the laser source 132 and the detector 134. In particular, the controller 144 may be configured to capture or otherwise receive the signal generated by the detector 134 and convert the signal to a two-dimensional image or a three-dimensional volume, for example by performing a polar coordinate to rectangular coordinate transformation that converts the signal to a two-dimensional image. The controller 144 may be further configured to control the microscopy device 100 to maintain a predetermined optical energy deposition per unit area while the radial distance 110 of the radial optical assembly 106 changes. For example, the controller 144 may increase repetition rate of the laser source 132 while the radial distance increases, or the controller 144 may decrease rotation rate of the rotational optical assembly 102 while the radial distance 110 increases.

The controller 144 may be embodied as any controller, microcontroller, microprocessor, digital signal processor, or other control circuit capable of performing the operations described herein. For example, in some embodiments the controller 144 may be embodied as a single or multi-core processor(s), digital signal processor, microcontroller, application-specific integrated circuit (ASIC), field-programmable gate array (FPGA), or other processor or processing/controlling circuit. As another example, in some embodiments the controller 144 may be embodied as without limitation, a desktop computer, a laptop computer, a tablet computer, a wearable computer, a smartphone, a consumer electronic device, a workstation, a server, a rack-mounted server, a blade server, a network appliance, a web appliance, a distributed computing system, a multiprocessor system, and/or any other computing device capable of performing the functions described herein. Accordingly, the controller 144 may include one or more components commonly found in a workstation or other computing device, such as a processor, an I/O subsystem, memory, a data storage device, communication circuitry, various input/output devices, and/or other components. Additionally or alternatively, although illustrated as a single controller 144, it should be understood that in some embodiments the microscopy device 100 may include multiple controllers, control circuits, or other control devices configured to perform the functions described herein.

Additionally or alternatively, it should be understood that in some embodiments, one or more of those functions of the controller 144 may be performed by an external computing device 145, such as without limitation, a desktop computer, a laptop computer, a tablet computer, a wearable computer, a smartphone, a consumer electronic device, a workstation, a server, a rack-mounted server, a blade server, a network appliance, a web appliance, a distributed computing system, a multiprocessor system, and/or any other computing device capable of performing the functions described herein. For example, in an embodiment the external computing device 145 may receive the signal generated by the detector 134 and convert the signal to a two-dimensional image or a three-dimensional volume, for example by performing a polar coordinate to rectangular coordinate transformation that converts the signal to a two-dimensional image.

Referring now to FIG. 1B, another potential embodiment of a microscope device 150 is shown. The microscopy device 150 shown in FIG. 1B includes many of the same components as the microscopy device 100 shown in FIG. 1A. Accordingly, the same reference numbers are used in FIG. 1B to identify features that are the same or similar to those described above in connection with FIG. 1A, the description of which is not repeated herein so as not to obscure the present disclosure.

As shown in FIG. 1B, the illustrative microscopy device 150 includes beam delivery optics 114, 122, similar to the device 100 shown in FIG. 1A. However, rather than prisms as shown in FIG. 1B, the device 150 includes multiple flat mirrors to direct the laser light 138 to the objective lens 126 (and back). In particular, the beam delivery optics 114 include flat mirrors 152, 154, 156 that are arranged to reflect light incident along the rotational axis 104 to the radial optical assembly 106. Similarly, the beam delivery optics 122 include a flat mirror 158 configured to reflect one or more laser beams received from the beam delivery optics 114 to the objective lens 126 (and back).

Referring now to FIG. 1C, another potential embodiment of a microscope device 160 is shown. The microscopy device 160 shown in FIG. 1C includes many of the same components as the microscopy device 100 shown in FIG. 1A and the microscopy device 150 shown in FIG. 1B. Accordingly, the same reference numbers are used in FIG. 1C to identify features that are the same or similar to those described above in connection with FIGS. 1A and 1B, the description of which is not repeated herein so as not to obscure the present disclosure.

As shown in FIG. 1C, in the illustrative microscopy device 160, the beam delivery optics 114, 122 have been replace with a single optical component 162, which is illustratively a glass plate 162. The glass plate 162 is configured to rotate relative to the rotational optical assembly 102 about a secondary rotational axis 164, which is perpendicular to the rotational axis 104. An illustrative rotational direction of the glass plate 162 is shown by arrow 166 in FIG. 1C. In use, rotation of the glass plate 162 causes displacement of the beam 138 in the radial direction 110. The radial optical assembly 106 is moved in the radial direction 110 synchronously with displacement of the beam 138, and thus the radially displaced beam is transmitted to the objective lens 126 within the radial optical assembly 106.

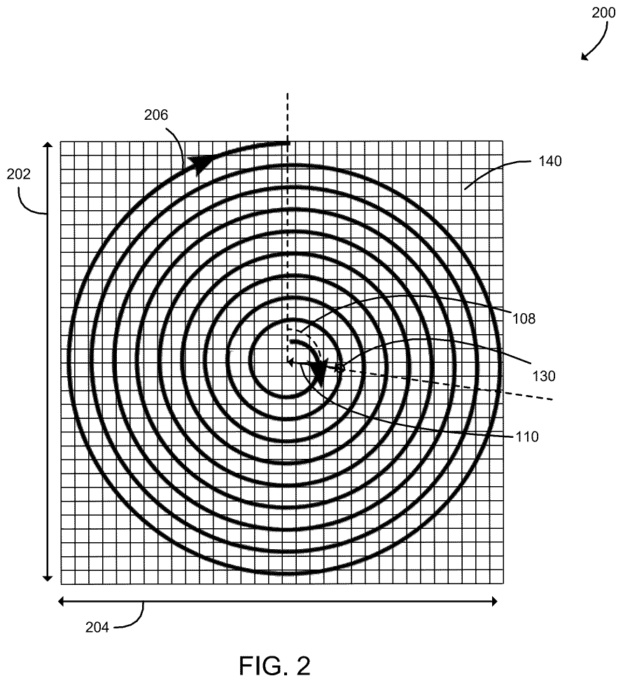

Referring now to FIG. 2, diagram 200 illustrates an example spiral scanning trajectory that may be defined using the microscopy device 100. The diagram 200 illustrates the sample 140, which is illustratively flat and rectangular in shape, having a height 202 and a width 204. A spiral trajectory 206 is shown, which represents the path of the objective lens 126 over the sample 140 while the rotational optical assembly 102 is rotated and the radial optical assembly 106 is translated radially. The diagram 200 illustrates the focus point 130 positioned on the sample 140 at an illustrative rotational angle 108 and radial distance 110. By continuing to vary rotational angle 108 and radial distance 110, the spiral trajectory 206 covers the roughly circular center part of the sample 140 at a resolution or pitch determined by the change in radial distance 110 for each full rotation. Accordingly, the microscopy device 100 effectively images the sample 140 for a field of view defined by the height 202 and the width 204. In embodiment, the height 202 and the width 204 may be relatively large lengths, such as 1 mm, 4 mm, 8 mm, 10 mm, or another length. Additionally, the scanning trajectory 206 is continuous (i.e., without raster line reversal), and the relatively large field of view may be captured with a continuous scan, without tiling or otherwise combining multiple scans.

Mechanical scanning as disclosed by the device 100 decouples field of view (FOV) and focusing numerical aperture (NA). For example, typical large-NA lenses (i.e., having NA>0.8) are available at magnifications of 20× or more, which have correspondingly smaller FOV. Inversely, lower magnification lenses (e.g., <10×) have wider FOVs but tend to have smaller NA (e.g., less than or equal to about 0.5). Large FOV lenses with large NA tend to be extremely massive and expensive. For example, one special-purpose custom 4.5× objective lens with a relatively large NA has a mass of over 4 kg. In contrast, the illustrative device 100 may use a lightweight, commercially available lens having an NA of above 0.5 (e.g., 0.6 or 0.7) and collect image data over a relatively large mechanically scanned FOV.

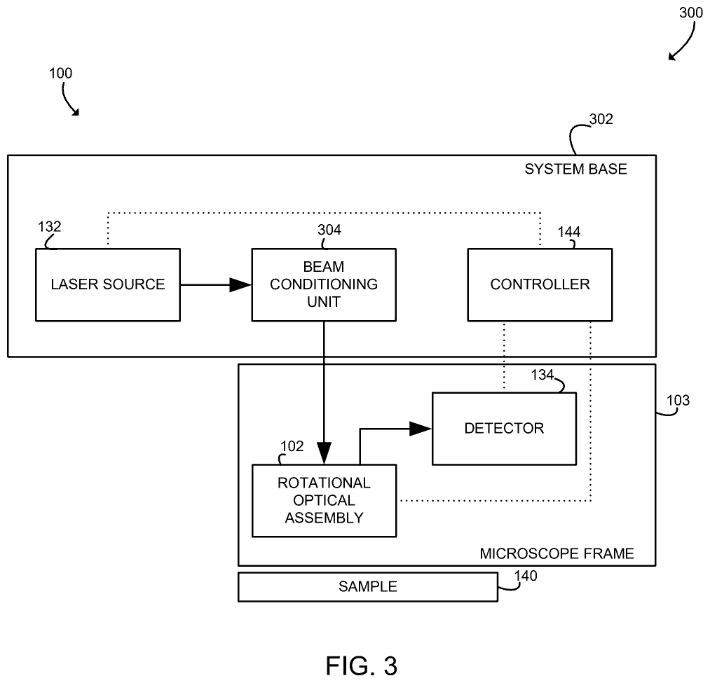

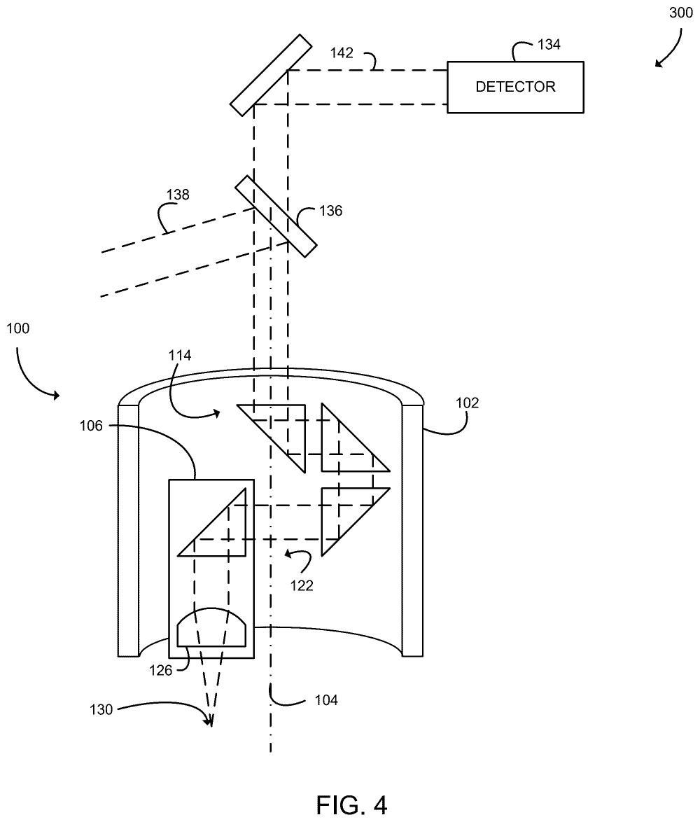

Referring now to FIGS. 3 and 4, an illustrative embodiment 300 of a nonlinear microscopy device 100 is shown. As shown in FIG. 3, the embodiment 300 includes a laser source 132 coupled to a system base 302. Laser light generated by the laser source 132 passes through a beam conditioning unit 304, which may include one or more divergence control units, nonlinear conversion units, optical amplifiers, pulse modulation units, pulse pickers, polarization control units, pulse delay control units, beam pointing control units, and/or other beam conditioning components. As described above, the beam conditioning unit 304 may be mechanically coupled to, for example, the laser source 132 or the system base 302 for the embodiment 300. In some embodiments, the beam conditioning unit 304 may be incorporated in the laser source 132. The microscopy device 100 is also coupled to the microscope frame 103, including the rotational optical assembly 102, the detector 134, and one or more controllers 144.

As shown in a schematic diagram in FIG. 4, in the illustrative embodiment 300, laser light 138 from the laser source 132 enters the device 100 and is reflected by the beam splitter 136 along the rotational axis 104 toward the beam delivery optics 114, 122 within the rotational optical assembly 102. The beam delivery optics 114, 122 direct the laser light 138 to the objective lens 126, which focuses the laser light 138 to the focus point 130, at which point 130 a sample may be placed. Secondary light 142 generated by the sample is collected by the objective lens 126 and directed by the beam delivery optics 114, 122 back toward the beam splitter 136. The secondary light 142 is transmitted through the beam splitter 136 and enters the detector 134, which detects the secondary light 142 and may be used to generate an image of the sample.

Accordingly, a device 100 may be capable of capturing images at a medium resolution at a medically-relevant 10 mm imaging scale. The imaging scale may be up to 10 mm in some embodiments. In some embodiments, the imaging scale is not limited to 10 mm, because construction of the device 100 may be modified to expand the imaging scale range. The illustrative device 100 combines a relatively large FOV (10 mm) with a medium NA (0.6-0.8). The device 100 may be used for applications such as label-free optical biopsy of collagenous and myosin-containing structures (e.g., skin, cornea, muscle, etc.) using second harmonic generation (SHG). Other applications include cell cultures, in vitro cell models, high throughput screening, ELISA (Enzyme-Linked Immunosorbent Assay), liposomes, vesicles, cell nuclei counting and cell or tissue morphology using third harmonic generation (THG) and/or multiphoton excitation fluorescence (MPEF), for example for pathology and cancer diagnostics. Other applications include label-free fibrational imaging using coherent anti-Stokes Raman scattering (CARS) and/or stimulated Raman scattering (SRS) with a dual-color laser source. Imaging speed depends on scanner rotation rate and the number of spirals. For example, for a 200 Hz rate, a 10 mm FOV, a 1 μm resolution, and a 1 μm step size, an image may be captured in <20 seconds. Other applications include imaging using linear absorption, reflectance, or single-photon induced fluorescence.

As described above, while performing spiral scanning, the controller 144 may perform variable repetition rate control of the laser source 132 to ensure a predetermined optical energy deposition per unit area (i.e., a constant excitation intensity per square millimeter or other area unit, or other pre-selected measurement of optical energy deposition per area). Detection data from the detector 134 is collected in polar format (e.g., each detection intensity “pixel” is identified by radial distance and angle (r, θ)). Certain statistics and other data may be derived from the polar data, such as signal intensity, variation, and channel utilization. After collecting polar data, the controller 144 performs XY rastering, which calculates an XY Cartesian image from the polar data. In some embodiments, the controller 144 may perform XYZ rastering, which calculates XYZ Cartesian volume data or voxels from polar data (for example, where each detection intensity “voxel” is identified by radial distance, angle, and depth (r, θ, z)). Of course, in other embodiments the controller 144 may perform any other appropriate technique to reconstruct image data and/or volume data from the detection data.

In some embodiments, multiple images at several resolutions may be calculated in parallel. Thumbnail images with certain small resolutions are guaranteed to have polar data for each XY Cartesian pixel, and thus require no additional processing for display. The controller 144 (or other device) may thus display such low resolution thumbnail images in real time or near real time. For example, thumbnail images may be displayed at a higher frames per second and lower latency for time-critical tasks. Higher-resolution XY images use interpolation to fill missing pixels. In those images, resolution becomes a function of radial distance r. In some embodiments, a parallel artificial intelligence (AI) infilling process may be trained for repetitive imaging tasks. Such AI infilling may reduce resolution trade-off as compared to interpolation. After interpolation and/or AI infilling, channels may be combined to R, G, B format for storage and display.

Although illustrated and described as being performed by the controller 144, it should be understood that in some embodiments one or more of those processes may be performed by a different computing device, such as one or more computer workstations, servers, desktop computers, laptop computers, and/or other computing devices.

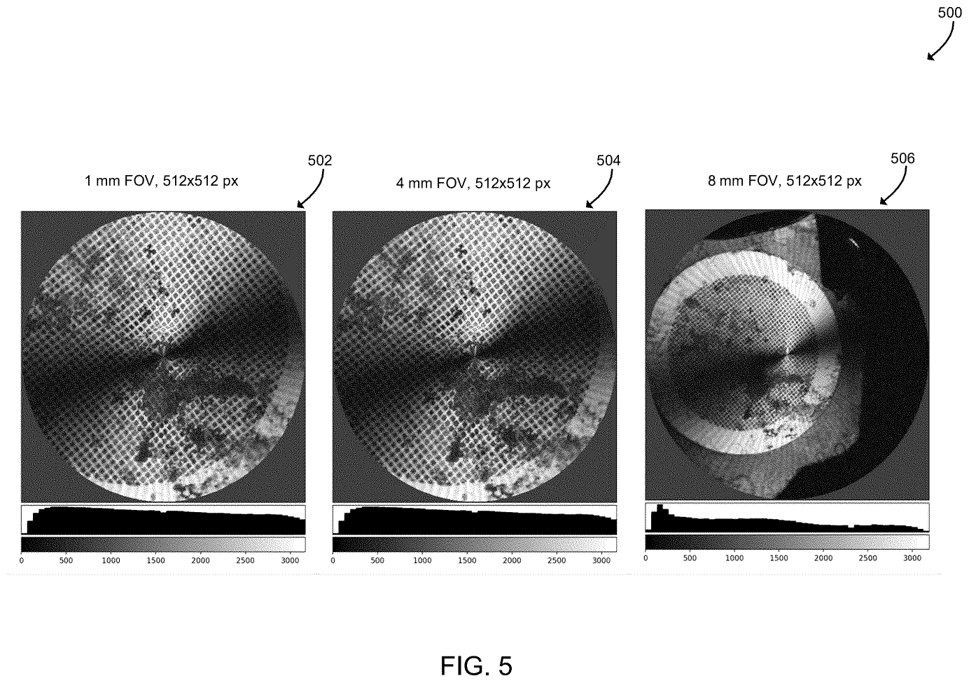

Referring now to FIG. 5, diagram 500 illustrates experimental results that may be achieved by an illustrative microscopy device 100 as shown in the illustrative embodiment 300. In an experiment, a prototype device 100 was used to capture second harmonic generation (SHG) images of a 50 μm pitch transmission electron microscope (TEM) support grid on a thin beta barium borate (BBO) crystal. The sample was scanned and imaged as described above while rotating the rotational optical assembly 102 and translating the radial optical assembly 106. Image 502 represents data captured with a 1 mm field of view (FOV), image 504 represents data captured with a 4 mm FOV, and image 506 represents data captured with an 8 mm FOV. As shown, the captured images 502, 504, 506 correctly display the rectangular TEM grid, indicating that polar to rectangular coordinate conversion was performed correctly. The bright-dark cross pattern is due to linear polarization rotation of the scanning device 100. Circular polarization may be used for polarization-sensitive imaging such as SHG. Note that the 8 mm FOV shown in image 506, made using an 0.4 NA optic, already exceeds the capabilities of a typical biomedical 10×/0.3 2.5 mm FOV objective.

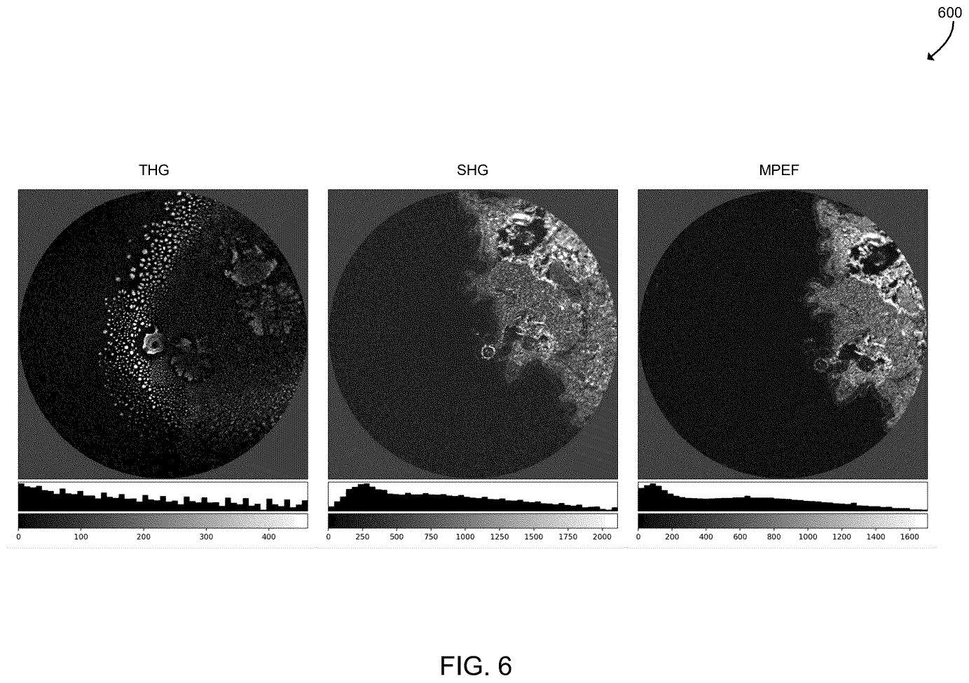

Referring now to FIG. 6, diagram 600 illustrates additional experimental results that may be achieved by an illustrative microscopy device 100 as shown in the illustrative embodiment 300. In another experiment, a skin melanoma sample was H&E stained and imaged with the device 100 using an 8 mm FOV. SHG, THG, and MPEF signals were collected. In the captured images shown in the diagram 600, the SHG channel shows collagen while MPEF shows H&E fluorescence. THG shows cell nuclei and tissue voids. The large FOV reveals nuclei distribution which may be useful for segmentation, counting, and morphology analysis. As shown, the SHG and MPEF images may start to lack resolution at such large FOVs to show individual collagen fibrils, but those channels do show the concentration of collagen in SHG and other proteins in MPEF.

Referring now to FIG. 7, diagram 700 illustrates one potential embodiment of a microscope device 100 using single detector 134 in an epi-configuration. Since in the illustrative embodiment the secondary light has passed through the scanner on its way to the detector 134, the emission beam is automatically descanned and thus stationary. As shown, a dichroic mirror 136 is used to separate the excitation beam 138 and the emission/detection light 142. A device 100 with a single detector 134 may have minimal filtering optics and thus the highest collection efficiency as compared to other collection configurations. A lens relay for the emission light 142 as shown in the diagram 700 is optional, and may improve collection.

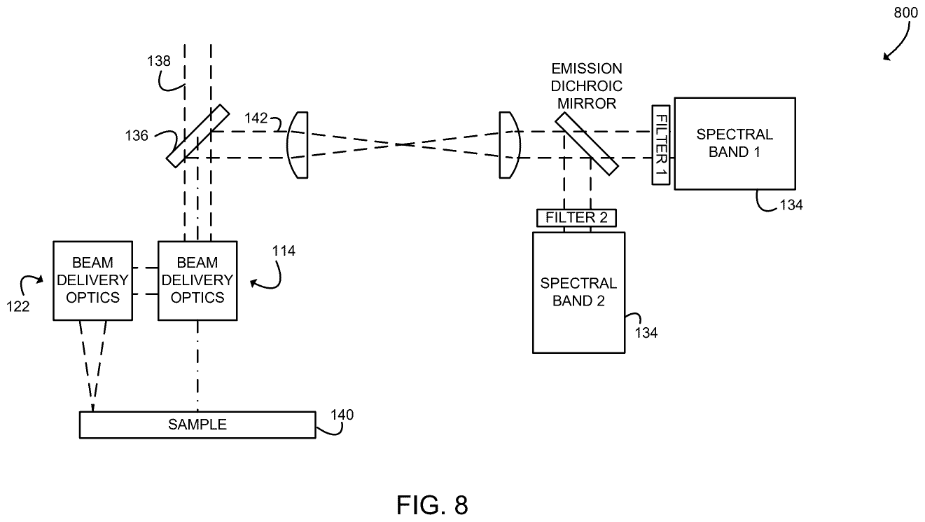

Referring now to FIG. 8, diagram 800 illustrates another potential embodiment of a microscope device 100 using multiple detectors 134 in an epi-configuration. Since in the illustrative embodiment the secondary light has passed through the scanner on its way to the detector 134, the emission beam is automatically descanned and thus stationary. As shown, a dichroic mirror 136 is used to separate the excitation beam 138 and the emission/detection light 142. One or more emission filters may split the emission beam 142 spectrally. The illustrative diagram 800 shows two detectors 134 that detect light in two spectral bands. Additionally or alternatively, in some embodiments, one or more emission filters can be polarization-sensitive, for example, for polarization-resolved detection or demultiplexing. A lens relay for the emission light 142 as shown in the diagram 700 is optional, and may improve collection.

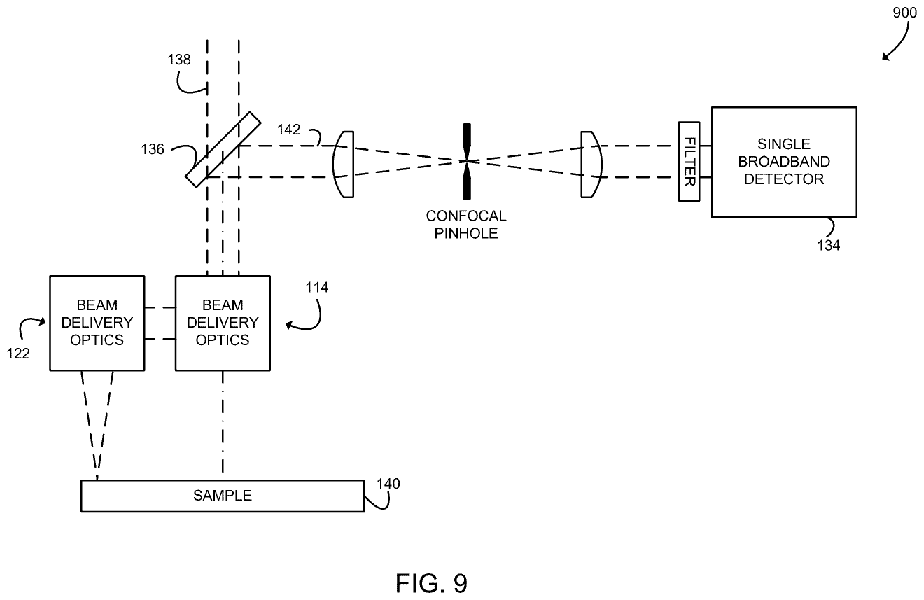

Referring now to FIG. 9, diagram 900 illustrates another potential embodiment of a microscope device 100 using a confocal epi-configuration detector. Since in the illustrative embodiment the secondary light has passed through the scanner on its way to the detector 134, the emission beam is automatically descanned and thus stationary. As shown, a splitting/dichroic mirror 136 is used to separate the excitation beam 138 and the emission/detection light 142. A pinhole is placed in the focal plane of the lens relay for the emission light 142. The diameter of the pinhole can be fixed or adjusted either by means of an adjustable iris or a pinhole wheel in order to change the confocal depth and the amount of light passed to the detector. The confocal cpi-configuration detector 134 may be used, for example, for confocal reflectometry, profilometry, polarimetry, and/or one-photon fluorescence imaging. In reflectance detection, the excitation beam 138 can be provided by the same laser source 132 or a separate laser module, and the splitting mirror 136 is chosen such that some of the excitation light is passed through to the detector 134 (e.g., 50/50 reflectance/transmission). The splitting mirror 136 can be made polarization sensitive, e.g., reflecting the polarized excitation and transmitting a perpendicular polarization to detect polarization changes in the reflected light. Furthermore, for linear fluorescence detection the excitation beam 138 wavelength is chosen based on the excitation spectra of the sample, and provided cither by the laser source 132 or a separate laser module. In all linear signal modality cases, the laser source may be pulsed or continuous-wave.

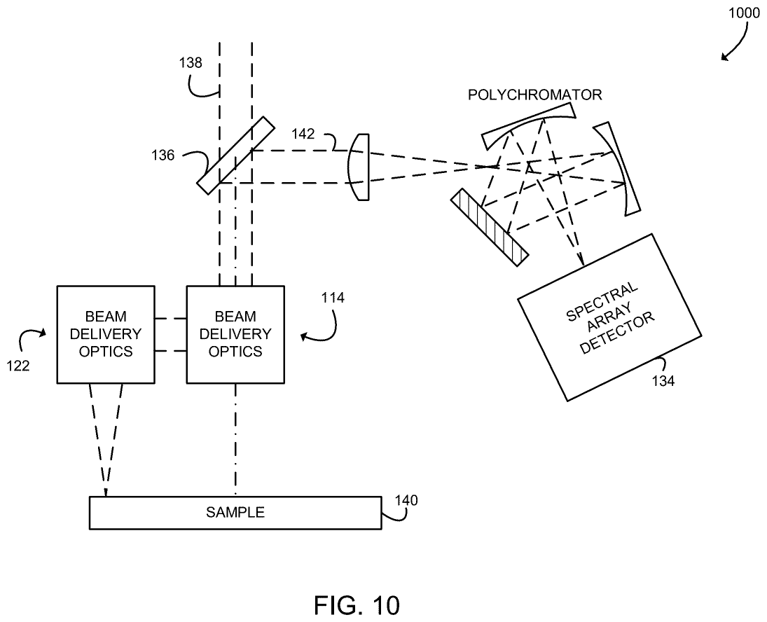

Referring now to FIG. 10, diagram 1000 illustrates another potential embodiment of a microscope device 100 using spectral detection in an cpi-configuration. Since in the illustrative embodiment the secondary light has passed through the scanner on its way to the detector, the emission beam is automatically descanned and thus stationary. As shown, a dichroic mirror 136 is used to separate the excitation beam 138 and the emission/detection light 142. The emission light 142 is focused to the entrance slit of a polychromator for spectrally-resolved detection with a multi-element detector (e.g., a spectrometer). This configuration may be used, for example, for spectrally-resolved fluorescence, time-correlated single-photon counting (TCSPC), coherent Raman scattering (CARS and SRS), and/or pump-probe spectroscopy.

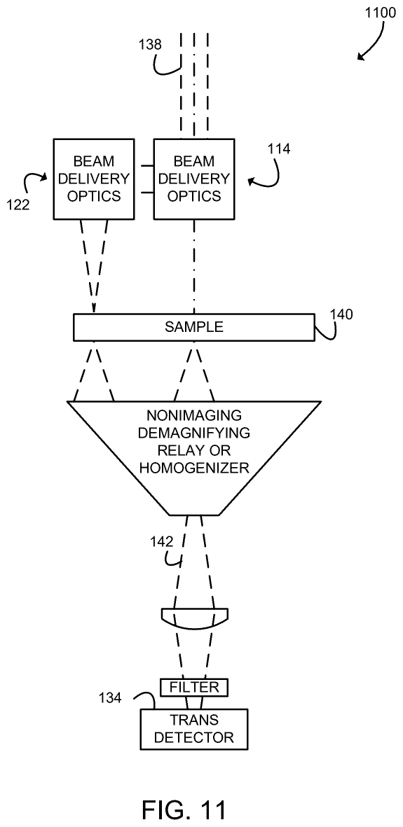

Referring now to FIG. 11, diagram 1100 illustrates one potential embodiment of a microscope device 100 using a trans-configuration detector. Detection in the trans direction is non-descanned, meaning that the emission light 142 originates from different positions on the sample 140. Accordingly, a de-magnifying optical system or other collection lens may be used to image the scan area onto the active area of the detector 134. Alternatively, a large-area nonimaging relay or homogenizer may be used to collect the transmitted light 142 onto a detector 134 with a small detection area. This relay optic may have relaxed design properties, as it may not need high-quality imaging properties, just transfer of light from the sample 140 to the detector 134. This detection technique may be used for coherent signals that are predominantly emitted in the forward direction (e.g., SHG, THG, CARS, SRS, PP).

In some embodiments, the total imaging area of the nonlinear microscopy apparatus can be increased beyond the circular area covered by a single scan field of view (e.g., a diameter of about 10 mm) by utilizing tiling. As described further below, in such embodiments, the sample is placed on a motorized three-dimensional (i.e., XYZ) translation stage and moved either between scans or in conjunction with the spiral scanner.

In addition to tiling geometries utilized to fill image areas larger than a single scan FOV, the disclosed scanner has a throughput advantage when the spinning radius and the corresponding linear scan speed and pixel acquisition throughput are high. In variable-radius scanning, the pixel throughput increases from the center to the periphery. By keeping the scanner spinning at the largest radius and continuously moving the sample stage at a constant velocity, the high-throughput pixel acquisition can be maintained over a larger portion of the sample. For example, at a rotation speed of 200 Hz and a pixel size of 1 μm, the rotating scanner reaches a 1 μs pixel dwell and a throughput of 1 MPx/s that is typical for galvo scanners at a radius of ˜1 mm, and the throughput increases to ˜10 MPx/s at a radius of 10 mm.

In one embodiment, the sample stage is moved in a move-stop-acquire image mosaic tiling procedure, where each tile is captured by a single spiral scan while the sample stage is stationary. The mosaic tiles can be arranged in a rectangular or hexagonal grid, and the mosaic tile geometry can take on any shape to adapt to high aspect ratio or irregular samples. The final image is stitched together from individual tiles either by assuming that the absolute mosaic stage positions are correct or by overlapping the tiles and using image registration to correct for tile scale and position offset errors. Using the latter method allows a relatively coarse sample stage to be used since the position error can be corrected in stitching. Suitable sample stages include stepper or DC motor-driven stages with 50-500 mm travel ranges with an accuracy of ˜1-100 μm and travel speed of 20-100 mm/s. The XY transverse characteristics of the stage can be different (e.g., coarser) than the axial Z characteristics of the stage.

In another embodiment, in a strip tiling procedure, the sample stage is continuously translated while the scanner spins at a fixed maximum radius to maintain the highest pixel acquisition density. The angular position and radius of the scanner and the position of the stage are driven and tracked by the scanner controller in order to assign the illuminated sample locations to image pixels. The forward and backward scanner arc passes can be used to build two translated copies of the sample image which are then averaged, or the laser can be disabled during the backward pass. Suitable sample stages include stepper and DC motor-driven stages as described in the mosaic tiling embodiment, as well as linear motor stages. In the continuous movement strip tiling embodiment, the consistency of the stage speed becomes important as well as the ability to track the stage position and speed during the scanning/movement. DC-motor stages with encoders and linear motor stages tend to perform better with typical velocity stability <±1 mm/s.

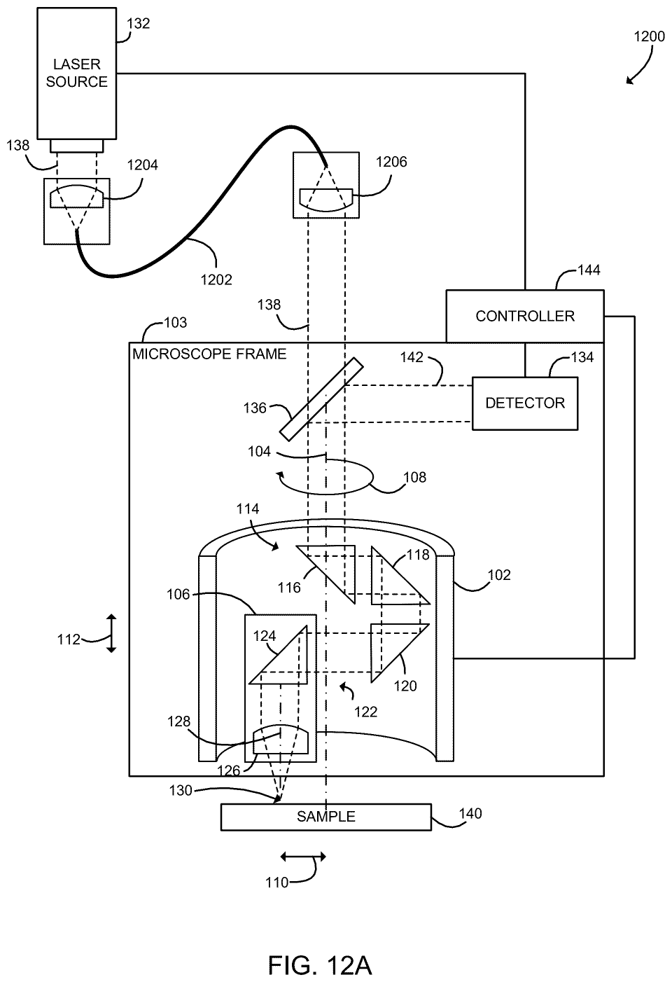

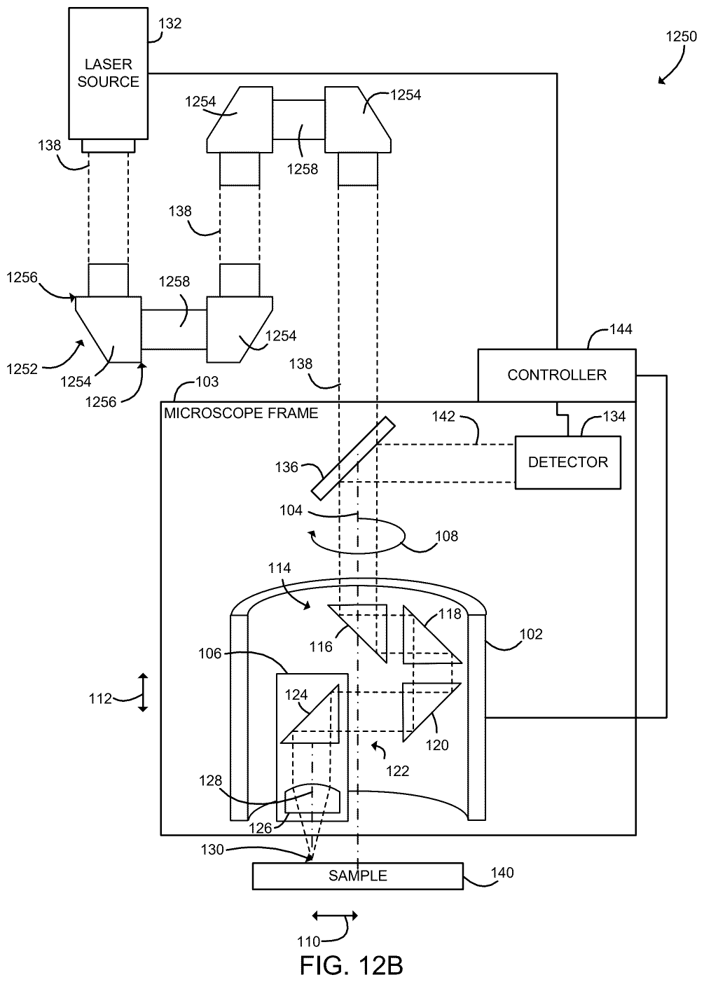

Referring now to FIG. 12A, another potential embodiment of a nonlinear microscopy device 1200 is shown. The microscopy device 1200 shown in FIG. 12A includes many of the same components as the microscopy devices 100, 150, 160 shown in FIGS. 1A-1C. Accordingly, the same reference numbers are used in FIG. 12A to identify features that are the same or similar to those described in connection with FIGS. 1A-1C, the description of which is not repeated herein so as not to obscure the present disclosure.

As shown, in the illustrative device 1200, the spiral scanner unit 103 is decoupled from the laser head 132. In an embodiment, the spiral scanner unit 103 may be placed on a separate articulated platform so that it can be translated freely in 3D without moving the laser 132. This 3D translation of the scanning mechanism allows the scan field of view to be positioned over a patient that is lying down, sitting or standing, or an object that cannot be moved under a fixed microscope. Translation also allows the microscope to be moved out of the way and back again in a repeatable manner. In some embodiments, the weight of the scanner unit may be compensated either with passive actuators (e.g., preloaded springs, compressed gas cylinders, etc.) or active servo systems.

In the illustrative embodiment, the beam 138 from the laser head 132 to the scanner unit 103 is delivered via an optical fiber 1202. For fiber delivery, the beam 138 is coupled to the optical fiber 1202 at the laser head 132, for example by a lens 1204, and then the beam 138 is coupled from the optical fiber 1202 to the scanner unit 103, for example by a lens 1206. In some embodiments, the lens 1206 may be attached to or otherwise mechanically coupled to the microscope frame 103 or other assembly at the scanner unit. In an illustrative embodiment, an optical fiber 1202 with a hollow-core, negative curvature or other anti-resonant design may be used for the delivery of high-intensity and broadband pulses. The optical fiber 1202 may be embodied as a solid-core photonic crystal, a hollow-core photonic crystal, or a negative curvature optical fiber or other anti-resonant fiber designs, and/or also photonic bandgap fiber designs.

Referring now to FIG. 12B, another potential embodiment of a nonlinear microscopy device 1250 is shown. The microscopy device 1250 shown in FIG. 12B includes many of the same components as the microscopy devices 100, 150, 160, 1200 shown in FIGS. 1A-1C and 12A. Accordingly, the same reference numbers are used in FIG. 12B to identify features that are the same or similar to those described in connection with FIGS. 1A-1C and 12A, the description of which is not repeated herein so as not to obscure the present disclosure.

Similar to the device 1200, the illustrative device 1250 also decouples the spiral scanner unit 103 from the laser head 132. In the illustrative embodiment, the beam 138 is delivered in free space using an articulated laser delivery arm 1252. The illustrative jointed articulated arm 1252 is used to transport the beam 138 from the laser head 132 to the scanner unit 103 using mirrors 1254 at joint rotation planes 1256 to change the direction of the beam 138. Lenses may be placed inside the delivery arm 1252 for beam relaying/divergence control. The delivery arm 1252 includes multiple joints, and segments 1258 between the joints may have adjustable lengths to provide positional freedom for the scanner unit 103.

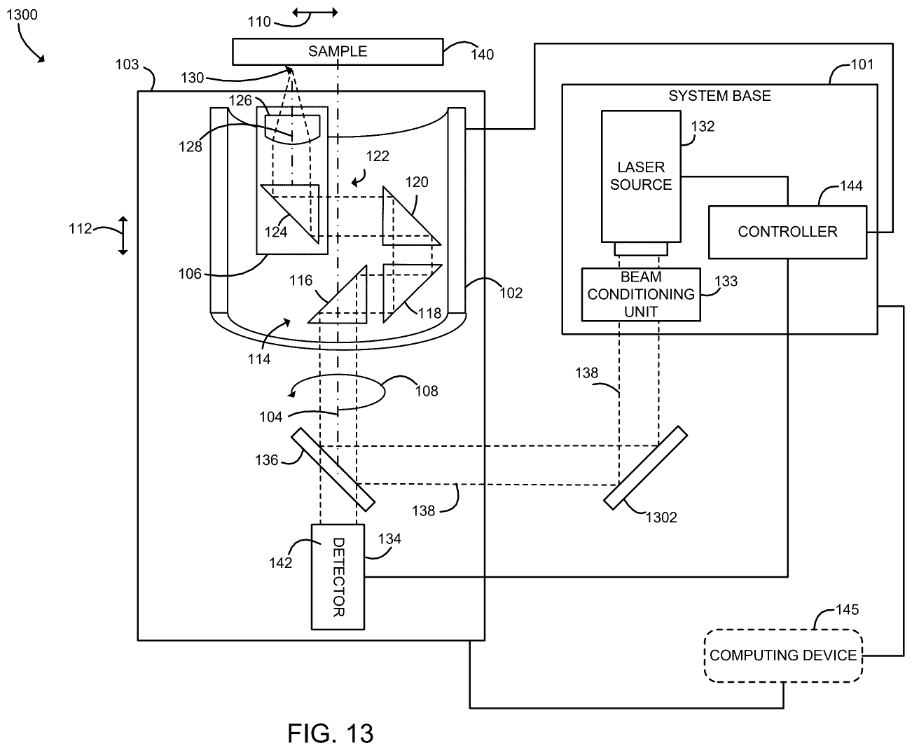

Referring now to FIG. 13, another potential embodiment of a nonlinear microscopy device 1300 is shown. The microscopy device 1300 shown in FIG. 13 includes many of the same components as the microscopy devices 100, 150, 160 shown in FIGS. 1A-IC. Accordingly, the same reference numbers are used in FIG. 13 to identify features that are the same or similar to those described in connection with FIGS. 1A-1C, the description of which is not repeated herein so as not to obscure the present disclosure.

As shown in FIG. 13, the illustrative device 1300 has an inverted orientation as compared to the upright orientation shown in FIGS. 1A-1C. In the inverted orientation of FIG. 13, the sample 140 is placed above the microscope frame 103 and its components, including the rotational optical assembly 102 and the radial optical assembly 106. As shown, in the illustrative embodiment of the device 1300, the system base 101 including the laser source 132 is positioned adjacent to the microscope frame 103, and the beam 138 is directed to the beam splitter 136 by a folding mirror 1302.

Accordingly, depending on the constraints of the imaging application, the nonlinear microscopy device may be oriented in an upright configuration similar to FIGS. 1A-1C or in an inverted configuration similar to FIG. 13. Beam delivery components and the rotating scanner assembly do not rely on a particular direction of gravity and the microscope can be thus inverted without changing key scanner components or its principle of operation.

An upright microscope orientation is beneficial because the sample 140 can be placed lower allowing the overall microscope envelope to be smaller or for automation purposes, e.g., with robotic slide loader. In the upright orientation, the excitation laser light reaches the focus point from above a nominal sample plane. An inverted microscope is typically required when working with liquid samples, cell cultures, and organoids, especially in culture dishes and multiwell plates. In the inverted orientation, the excitation laser light reaches the focus point from below the nominal sample plane. An inverted microscope having a large field of view and high resolution may be particularly advantageous when working with samples sensitive to mechanical perturbation, e.g., due to the acceleration and deceleration of the sample stage. The illustrated microscope device 1300 with a 10 mm field of view in an inverted configuration may be used to observe multiple sample positions or wellplate chambers without translating the sample 140.

Additionally or alternatively, combining upright and inverted excitation orientation as shown in FIGS. 1A-1C and 13 with epi and trans detection options as shown in FIG. 11 allows for four microscope configurations: upright-epi, upright-trans, inverted-epi, and inverted-trans. Those four configurations may be implemented separately for simplicity or may be implemented in a single device for flexibility.

In some embodiments, any of the nonlinear microscopy devices described above may be combined with a higher energy laser beam to perform ablation. For example, such a device with a higher energy beam may perform ablation-assisted diagnostics. Nonlinear excitation may be used in tandem with high-energy ablation for both visualization and targeted microsurgical functions. Such dual-mode operation allows for transition between high-resolution imaging and high-energy ablation. In some embodiments, the ablation may be performed using the same wavelength as the imaging beam but with a higher pulse energy. Depending on wavelength, pulse duration, numerical aperture, absorption, and tissue type, fluence for generally soft biological tissue (e.g., brain, cornea, skin) ablation should be ˜1-5 J/cm². The same optics can easily guide low-energy (e.g., from 1-2 nJ, but not limited to that range) femtosecond pulses for nonlinear microscopy as well as high energy (e.g., 10 μJ but not limited, e.g. 20 μJ is suitable for cataract ablation) femtosecond pulses for ablation without any additional modifications throughout the complete optical path. Depending on treatment option, both surface and immersed ablation (using intermediate suction glass as interface) could be performed when precise targeting is needed. The resolution could be varied if needed both for imaging and/or ablation, or in between, up to <1 μm, lowest. In an embodiment, the system is capable to focus within the volume of the material up to 2000 μm in air. Dependent on the material, the focus distance may be more. In an embodiment, the system is capable to switch between modalities: nonlinear-microscopy and ablation, within a few milliseconds.

In an embodiment, an ablation-assisted diagnostics procedure may include switching the system to microscopy mode, for example by reducing energy, setting numerical aperture, opening detector shutter, and opening laser shutter. The procedure further includes performing nonlinear imaging of a desired material or other sample. The procedure further includes identifying a surface and/or volume to be ablated. The procedure further includes switching the system to ablation mode, for example closing the laser shutter, closing the detector shutter, setting the numerical aperture, and increasing energy. The procedure further includes initiating ablation by opening the laser shutter. After ablation, the procedure further includes closing the laser shutter. The procedure may be repeated to detect ablation progress and perform additional ablation if needed.

Additionally or alternatively, a nonlinear microscope with a rotational scanner and detector may work as a surgical system. The same optical system can seamlessly deliver femtosecond pulses across a broad energy range—from low-energy levels (e.g., 1-2 nJ) for nonlinear microscopy to high-energy levels (e.g., 10 μJ or more) for ablation, as well as intermediate energies for tissue modification via multiphoton ionization—without requiring any changes to the optical components. The only exception is that in many embodiments the detector must be closed or shielded prior to ablation or surgical procedures. In some embodiments, the detector must be closed throughout the complete surgery, for protection. In some embodiments, a third harmonic generation (THG) detector signal could be used as a reference to detect glass interface surface for precise and accurate depth control.

What is claimed is:

1. A nonlinear microscopy apparatus comprising:
a laser source coupled to a system base;
a rotational optical assembly rotatably coupled to a microscope frame and configured to rotate relative to the microscope frame about an imaginary rotational axis, the rotational optical assembly including a radial optical assembly that is translatable radially relative to the imaginary rotational axis;
wherein the rotational optical assembly comprises beam delivery optics configured to transmit a first laser beam generated by the laser source coincident with the rotational axis to the radial optical assembly;
wherein the radial optical assembly comprises an objective lens in optical communication with the rotational optical assembly and configured to focus the first laser beam to a focus point;
a detector coupled to the microscope frame; and
a beam splitter optically coupled to the laser source and the rotational optical assembly, the beam splitter configured to direct the first laser beam to the rotational optical assembly and to direct secondary light received from the focus point through the rotational optical assembly to the detector;
wherein the detector is configured to generate a signal indicative of the secondary light received from the focus point through the rotational optical assembly.

2. The nonlinear microscopy apparatus of claim 1, further comprising a controller coupled to the rotational optical assembly, the radial optical assembly, and the detector, wherein the controller is configured to:
cause the rotational optical assembly to rotate;
cause the radial optical assembly to translate radially from a first position relative to the imaginary rotational axis to a second position relative to the imaginary rotational axis while the rotational optical assembly rotates;
capture first signal data indicative of the signal captured by the detector while the radial optical assembly translates from the first position to the second position; and
convert the first signal data to two-dimensional image data or three-dimensional volume data.

3. The nonlinear microscopy apparatus of claim 2, wherein the controller is further configured to maintain a predetermined optical energy deposition per unit area while the radial optical assembly translates.

4. The nonlinear microscopy apparatus of claim 2, wherein to cause the radial optical assembly to translate radially comprises to displace the radial optical assembly by a predetermined step size for every rotation of the rotational optical assembly.

5. The nonlinear microscopy apparatus of claim 2, wherein the controller is further configured to:
cause a sample stage to translate from a third position to a fourth position after capturing the first signal data;
cause the radial optical assembly to translate radially from the first position to the second position while the rotational optical assembly rotates after translation of the sample stage from the third position to the fourth position;
capture second signal data indicative of the signal captured by the detector while the radial optical assembly translates from the first position to the second position after the translation of the sample stage from the third position to the fourth position; and
combine the first signal data and the second signal data to generate the two-dimensional image data or the three-dimensional volume data.

6. The nonlinear microscopy apparatus of claim 2, wherein the controller is further configured to:
deactivate the detector after capturing the first signal data; and
increase a power level of the laser source to an ablation power level after deactivation of the detector, wherein the ablation power level causes ablation of a target material at the focus point.

7. The nonlinear microscopy apparatus of claim 1, further comprising a controller coupled to the rotational optical assembly, the radial optical assembly, and the detector, wherein the controller is configured to:
cause the rotational optical assembly to rotate;
cause the radial optical assembly to hold at a first radial position relative to the imaginary rotational axis while the rotational optical assembly rotates;
cause a sample stage to translate from a first position to a second position while the rotational optical assembly rotates;
capture first signal data indicative of the signal captured by the detector while the sample stage translates from the first position to the second position with the radial optical assembly at the first radial position; and
convert the first signal data to two-dimensional image data or three-dimensional volume data.

8. The nonlinear microscopy apparatus of claim 1, wherein the rotational optical assembly further comprises a counterbalance.

9. The nonlinear microscopy apparatus of claim 1, wherein the laser source comprises a mode locked solid state or fiber oscillator with a single laser beam, and wherein the single laser beam comprises:
a central wavelength in the range of 600 nm to 2200 nm;
a pulse energy in the range of 1 nJ to 1000 nJ;
a repetition rate in the range of 1 kHz to 100 MHz; and
a pulse duration in the range of 10 femtoseconds to 50 picoseconds.

10. The nonlinear microscopy apparatus of claim 1, wherein the secondary light originates in at least one process of multi-photon absorption induced fluorescence, second harmonic generation, third harmonic generation, stimulated Raman scattering, coherent anti-Stokes Raman scattering, linear absorption, reflectance, or single-photon induced fluorescence.

11. The nonlinear microscopy apparatus of claim 1, wherein the microscope frame is coupled to the system base.

12. The nonlinear microscopy apparatus of claim 1, wherein the microscope frame is movable relative to the system base.

13. The nonlinear microscopy apparatus of claim 1, wherein the focus point is positioned below the microscope frame.

14. The nonlinear microscopy apparatus of claim 1, wherein the focus point is positioned above the microscope frame.

15. A method for nonlinear microscopy comprising:
causing, by a controller, a rotational optical assembly to rotate about an imaginary rotational axis, wherein the rotational optical assembly is rotatably coupled to a microscope frame and includes a radial optical assembly that is translatable radially relative to the imaginary rotational axis, wherein the rotational optical assembly comprises beam delivery optics configured to transmit a first laser beam generated by a laser source coincident with the rotational axis to the radial optical assembly, and wherein the radial optical assembly comprises an objective lens in optical communication with the rotational optical assembly and configured to focus the first laser beam to a focus point;
causing, by the controller, the radial optical assembly to translate radially from a first position relative to the imaginary rotational axis to a second position relative to the imaginary rotational axis while the rotational optical assembly rotates;
capturing, by the controller, first signal data indicative of a signal captured by a detector while the radial optical assembly translates from the first position to the second position, wherein the detector is coupled to the microscope frame and is configured to generate a signal indicative of the secondary light received from the rotational optical assembly; and
converting, by the controller, the first signal data to two-dimensional image data or three-dimensional volume data.

16. The method of claim 15, further comprising maintaining, by the controller, a predetermined optical energy deposition per unit area while the radial optical assembly translates.

17. The method of claim 15, further comprising:
causing, by the controller, a sample stage to translate from a third position to a fourth position after capturing the first signal data;
causing, by the controller, the radial optical assembly to translate radially from the first position to the second position while the rotational optical assembly rotates after translating the sample stage from the third position to the fourth position;
capturing, by the controller, second signal data indicative of the signal captured by the detector while the radial optical assembly translates from the first position to the second position after translating the sample stage from the third position to the fourth position; and
combining, by the controller, the first signal data and the second signal data to generate the two-dimensional image data or the three-dimensional volume data.

18. The method of claim 15, further comprising:
deactivating, by the controller, the detector after capturing the first signal data; and
increasing, by the controller, a power level of the laser source to an ablation power level after deactivating the detector, wherein the ablation power level causes ablation of a target material at the focus point.

19. The method of claim 15, wherein the rotational optical assembly further comprises a counterbalance.

20. The method of claim 15, wherein the secondary light originates in at least one process of multi-photon absorption induced fluorescence, second harmonic generation, third harmonic generation, stimulated Raman scattering, coherent anti-Stokes Raman scattering, linear absorption, reflectance, or single-photon induced fluorescence.
